(19) United States
(12) Patent Application Publication
(10) Pub. No.: US 2026/0323237 A1
(43) Pub. Date: Oct. 15, 2026

(54) AUDIO PROCESSING METHOD AND APPARATUS, DEVICE, MEDIUM, AND PRODUCT

(71) Applicant: Tencent Technology (Shenzhen) Company Limited, Shenzhen (CN)

(72) Inventor: Bosheng CHEN, Shenzhen (CN)

(73) Assignee: Tencent Technology (Shenzhen) Company Limited, Shenzhen (CN)

(21) Appl. No.: 19/687,396

(22) Filed: May 26, 2026

Related U.S. Application Data
(63) Continuation of application No. PCT/CN2025/108605, filed on Jul. 15, 2025.

(30) Foreign Application Priority Data
Aug. 28, 2024 (CN) 202411187594.1

(51) Int. Cl. H04S 7/00

(52) U.S. Cl. CPC H04S 7/303; H04S 7/301; H04S 2400/01; H04S 2400/15

(57) ABSTRACT

An audio processing method includes obtaining a multi-channel media audio in a media playback scene, the multi-channel media audio comprising audio signals collected by using N channels, each of the N channels corresponding to a different spatial position in the media playback scene, obtaining a target spatial position of a media viewing object in the media playback scene, and deploying a stereo speaker system comprising N virtual speakers around the target spatial position in the media playback scene, a deployment position of each virtual speaker in the media playback scene matching a spatial position of one channel in the media playback scene, performing multi-channel audio rendering processing on the multi-channel media audio using the stereo speaker system, each virtual speaker in the stereo speaker system performing audio rendering processing on an audio signal collected by a matching channel, and playing, by the stereo speaker system, the multi-channel media audio.

### CROSS-REFERENCE TO RELATED APPLICATIONS

This application is a continuation application of International Application No. PCT/CN2025/108605 filed on Jul. 15, 2025, which claims priority to Chinese Patent Application No. 202411187594.1, filed with the China National Intellectual Property Administration on Aug. 28, 2024, the disclosures of each being incorporated by reference herein in their entireties.

### FIELD

The disclosure relates to the field of computer technologies, in particular, to an audio processing method and apparatus, a device, a medium, and a product, and specifically, to an audio processing method, an audio processing apparatus, a computer device, a computer-readable storage medium, and a computer program product.

### BACKGROUND

In the field of audio processing, spatial audio refers to capability of creating immersive experience based on directionality of sound, for example, immersive audiovisual experience such as watching a film and listening to a song. In a media playback device, a spatial audio component (for example, a speaker) can render and play an audio resource.

In the related art, if a to-be-played audio resource is in a single channel format, sound can be played only in a single channel. If an audio resource needing to be played is in a stereo sound or multi-channel format, all channels are mixed into a single channel before spatialization. In conclusion, a spatial audio component of a media playback device plays sound according to a single channel. Because there is only one channel, that is, there is only one source direction of sound, user experience is poor.

### SUMMARY

One or more embodiments provide an audio processing method and apparatus, a device, a medium, and a product, to achieve a rendering effect of a multi-channel spatial audio to improve immersive experience in a media playback scene.

One or more embodiments provide an audio processing method, including: obtaining a multi-channel media audio in a media playback scene, the multi-channel media audio comprising audio signals collected by using N channels, each of the N channels corresponding to a different spatial position in the media playback scene, and N being an integer greater than 1; obtaining a target spatial position of a media viewing object in the media playback scene, and deploying a stereo speaker system around the target spatial position in the media playback scene, the stereo speaker system comprising N virtual speakers, and a deployment position of each of the N virtual speakers in the media playback scene matching a spatial position of one of the N channels in the media playback scene; performing multi-channel audio rendering processing on the multi-channel media audio using the stereo speaker system, each of the N virtual speakers in the stereo speaker system performing audio rendering processing on an audio signal collected by a matching channel; and playing, by the stereo speaker system, the multi-channel media audio on which the multi-channel audio rendering processing is performed.

One or more embodiments provide an audio processing apparatus including: at least one memory configured to store computer program code; and at least one processor configured to read the program code and operate as instructed by the program code, the program code comprising: obtaining code configured to cause at least one of the at least one processor to obtain a multi-channel media audio in a media playback scene, the multi-channel media audio comprising audio signals collected by using N channels, each of the N channels corresponding to a different spatial position in the media playback scene, and N being an integer greater than 1; and processing code configured to cause at least one of the at least one processor to: obtain a target spatial position of a media viewing object in the media playback scene, and deploy a stereo speaker system around the target spatial position in the media playback scene; the stereo speaker system comprising N virtual speakers, and a deployment position of each of the N virtual speakers in the media playback scene matching a spatial position of one of the N channels in the media playback scene; perform multi-channel audio rendering processing on the multi-channel media audio by using the stereo speaker system, each of the N virtual speakers in the stereo speaker system performing audio rendering processing on an audio signal collected by a matching channel; and play, by the stereo speaker system, the multi-channel media audio on which the multi-channel audio rendering processing is performed.

One or more embodiments provide a non-transitory computer-readable storage medium, storing computer code which, when executed by at least one processor, causes the at least one processor to at least: obtain a multi-channel media audio in a media playback scene, the multi-channel media audio comprising audio signals collected by using N channels, each of the N channels corresponding to a different spatial position in the media playback scene, and N being an integer greater than 1; obtain a target spatial position of a media viewing object in the media playback scene, and deploying a stereo speaker system around the target spatial position in the media playback scene, the stereo speaker system comprising N virtual speakers, and a deployment position of each of the N virtual speakers in the media playback scene matching a spatial position of one of the N channels in the media playback scene; perform multi-channel audio rendering processing on the multi-channel media audio using the stereo speaker system, each of the N virtual speakers in the stereo speaker system performing audio rendering processing on an audio signal collected by a matching channel; and play, by the stereo speaker system, the multi-channel media audio on which the multi-channel audio rendering processing is performed.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a principle of an audio processing solution according to one or more embodiments;

FIG. 2 is a schematic structural diagram of a stereo speaker system according to one or more embodiments;

FIG. 3 is a schematic architectural diagram of an audio processing system according to one or more embodiments;

FIG. 4 is a schematic flowchart of an audio processing method according to one or more embodiments.

FIG. 5A is a schematic structural diagram of a multi-channel audio signal source according to one or more embodiments;

FIG. 5B is a schematic structural diagram of a multi-channel media audio according to one or more embodiments;

FIG. 6A is a schematic structural diagram of reference speaker deployment according to one or more embodiments;

FIG. 6B is a schematic structural diagram of deployment of a stereo speaker deployment system according to one or more embodiments;

FIG. 7 is a schematic diagram of multi-channel speaker deployment according to one or more embodiments;

FIG. 8 is a schematic flowchart of another audio processing method according to one or more embodiments.

FIG. 9 is a schematic flowchart of audio rendering according to one or more embodiments;

FIG. 10 is a schematic diagram of multi-channel rendering of a stereo speaker system according to one or more embodiments;

FIG. 11 is a schematic diagram of a media playback scene according to one or more embodiments;

FIG. 12 is a schematic structural diagram of an audio processing apparatus according to one or more embodiments; and

FIG. 13 is a schematic structural diagram of a computer device according to one or more embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

According to some embodiments, a multi-channel media audio in a media playback scene is obtained, the multi-channel media audio including audio signals collected by using N channels, each channel corresponding to a different spatial position in the media playback scene, and N being an integer greater than 1; a target spatial position of a media data viewing object in the media playback scene is obtained, and a stereo speaker system is deployed around the target spatial position in the media playback scene; and the stereo speaker system including N virtual speakers, and a deployment position of each virtual speaker in the media playback scene matching a spatial position of a channel in the media playback scene. As can be seen, in some embodiments, in a process of deploying the stereo speaker system, virtual recovery can be performed according to a spatial position of the multi-channel media audio during collection, to determine a deployment position of a virtual speaker, so that a real sound environment of the media audio can be recovered as much as possible in the media playback scene, thereby improving realness of an audio playback effect. Multi-channel audio rendering processing is performed on the multi-channel media audio by using the stereo speaker system, each virtual speaker in the stereo speaker system performing audio rendering processing on an audio signal collected by a matching channel. The multi-channel media audio on which the multi-channel audio rendering processing is performed is played by using the stereo speaker system. As can be seen, in some embodiments, N virtual speakers are configured to separately render audio signals collected by N channels, so that a rendering effect of the multi-channel spatial audio can be achieved, and three-dimensional and spatial quality of audio playback are improved, thereby improving immersive experience in the media playback scene.

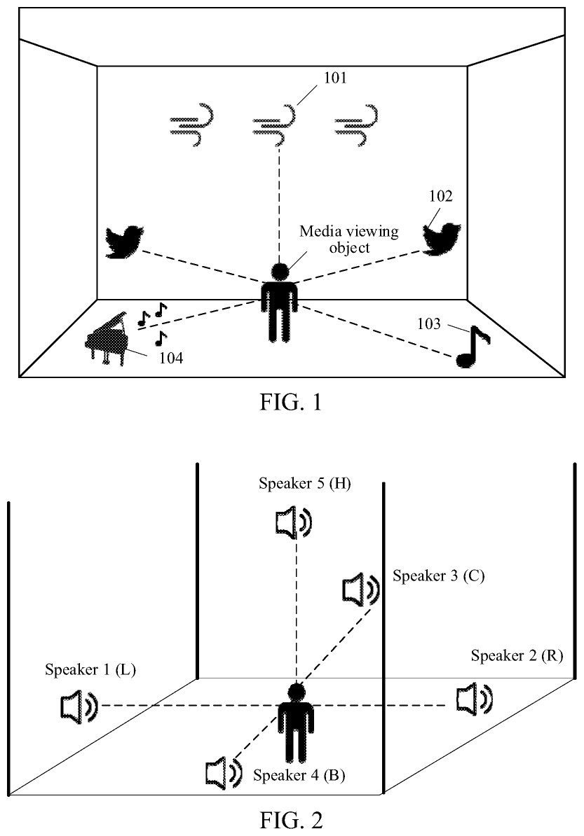

Some embodiments an audio processing solution, applicable to multi-channel audio playback on any type of media audio collected by multiple channels. The solution can achieve a multi-channel spatial audio rendering effect in a media playback scene, to virtually recover a real sound environment during a signal collection process as much as possible, thereby improving realness of an audio playback effect and improving immersive experience of a media viewing object. Specifically, referring to FIG. 1, FIG. 1 is a schematic diagram of a principle of an audio processing solution according to one or more embodiments. The principle of the audio processing solution provided in some embodiments is roughly described below with reference to FIG. 1. The principle of the solution mainly includes the following operations (1) to (4):
(1) Obtain a to-be-played multi-channel media audio in a media playback scene, where the multi-channel media audio includes audio signals (for example, different types of channels such as a left channel, a right channel, a front channel, and a rear channel) collected by using N (N is an integer greater than 1) channels. Each channel corresponds to a different spatial position in the media playback scene (for example, a left channel corresponds to a position on the left of a media viewing object in the media playback scene, and a right channel corresponds to a position on the right of the media viewing object in the media playback scene). The media playback scene refers to a scene of a real space environment for playing a multi-channel media audio, for example, any type of three-dimensional space scene such as a movie playback scene, a television drama playback scene, or a live broadcast scene.
(2) Obtain a target spatial position of a media viewing object in the media playback scene. As shown in FIG. 1, the media viewing object may be located at any position in the media playback scene (for example, a position right in the middle of the media playback scene).
(3) Deploy a stereo speaker system around the target spatial position in the media playback scene. Specifically, because the multi-channel media audio is obtained by collecting signals by using N channels, N virtual speakers need to be deployed herein to play the multi-channel media audio. In some embodiments, deployment information (for example, a deployment position and direction) of each to-be-deployed virtual speaker may be determined based on the target spatial position, and then the N virtual speakers are deployed in the media playback scene according to the deployment information, so that the stereo speaker system can be deployed around a media playback object. A deployment position of each virtual speaker in the media playback scene matches a spatial position of one channel in the media playback scene (for example, the deployment position is the same as a spatial position during collection or a distance between the deployment position and the spatial position is less than a preset threshold). That is, when deploying the virtual speaker, a spatial position of the speaker during signal collection is recovered as much as possible. In this way, the stereo speaker system can be deployed around the media viewing object according to a real-time position of the media viewing object.
(4) Perform multi-channel audio rendering processing on the multi-channel media audio by using the stereo speaker system; where each virtual speaker in the stereo speaker system performs audio rendering processing on an audio signal collected by a matching channel. That is, each virtual speaker performs audio rendering on an audio signal on a matching channel, so that a multi-channel media audio on which multi-channel audio rendering processing is performed is played by using the stereo speaker system, thereby achieving a multi-channel spatial audio playback effect. For example, in the media playback scene shown in FIG. 1, after multi-channel audio rendering is performed by using the stereo speaker system, for a media viewing object, a multi-directional or multi-channel audio playback effect can be achieved: bird song 102 at a valley in front of eyes, breeze 101 above the head, lingering music 103 behind, Guzheng and bell sound 104, and the like. This presents, based on an audio-visual synchronization manner, a poetic and gigantic media playback scene for the media viewing object, and brings immersive experience to users in the media playback scene.

In the audio processing solution provided in some embodiments, in a process of deploying the stereo speaker system, virtual recovery can be performed on a spatial position of the multi-channel media audio during collection, and the stereo speaker system can be deployed around the media viewing object based on a real-time position of the media viewing object, so that a real sound environment of the media audio can be recovered as much as possible in the media playback scene, thereby improving realness of an audio playback effect. In some embodiments, N virtual speakers are configured to separately render audio signals collected by N channels, so that a rendering effect of the multi-channel spatial rendering can be achieved, thereby improving immersive experience in the media playback scene.

Key technical terms in the disclosure are described below.

### 1. Channel.

A channel (also referred to as a sound track or an audio track) in the audio processing field is a transmission path of an audio signal, and is usually used for describing independent channels of different audio signals in an audio processing system. In short, mutually independent audio signals collected or played at different spatial positions when sound is recorded or played are referred to as sound tracks. A quantity of channels is referred to as a channel number for short, and is usually represented in an “X.Y” format, where “X” represents a quantity of main channels, and “Y” represents a quantity of low-frequency effect channels (LFE). For example, 2.0 channels: which represents left and right channels, and there is no independent low frequency channel (typical stereo configuration). For another example, 5.1 channel: which represents five main channels and one low frequency effect channel. For still another example, 7.1 channel: which represents seven main channels and one low frequency effect channel. Therefore, division according to a quantity of channels may include: single-channel and multi-channel. A single channel means that all audio signals are transmitted and played by using one channel. The single-channel is usually used in an audio playback scene with a low requirement on spatial quality, such as a call and a radio broadcast. Multiple channels mean that all audio signals are transmitted and played by using two or more channels. Therefore, an audio signal transmitted by using multiple channels has stereo and spatial quality. For example, the multiple channels include a left channel (L) and a right channel (R).

### 2. Multi-Channel Media Audio.

A multi-channel media audio, as the name implies, refers to a media audio or an audio signal transmitted and played by using multiple channels, is an audio system including multiple independent channels, and is applicable to complex audio playback scenes, such as movie production and game sound effect design. The multi-channel media audio allows more detailed and precise sound positioning, and usually includes 5.1, 7.1, 9.1, or even more channels. In some embodiments, the multi-channel media audio includes audio signals collected by using N channels. For example, the multi-channel media audio specifically includes N pieces of audio data, and one piece of audio data refers to an audio signal collected by using one channel. Therefore, a multi-channel media audio allows audio transmission and playback by using N channels (for example, a left channel, a right channel, front and rear channels, and upper and lower channels), to create immersive spatial and stereo quality.

### 3. Stereo Speaker System and Virtual Speaker.

A stereo speaker system refers to a speaker system having a stereo sound effect or a surround sound effect. The stereo sound effect refers to an audio playback effect having stereo and spatial quality. Multiple channels are used to surround a listener and create stronger immersive sound effect experience, so that the listener feels that sounds are transmitted from different directions. In some embodiments, the stereo speaker system includes N virtual speakers, and the stereo speaker system is deployed around a media viewing object, and the N virtual speakers are located at different spatial positions in the media playback scene. Referring to FIG. 2, FIG. 2 is a schematic structural diagram of a stereo speaker system according to one or more embodiments. As shown in FIG. 2, the stereo speaker system includes five virtual speakers: speakers 1, 2, 3, 4, and 5. In addition, spatial positions of different virtual speakers in the media playback scene are all deployed around the media viewing object. For example, a speaker 1 is located on the left of the media viewing object, a speaker 2 is located on the right of the media viewing object, a speaker 3 is located right in front of the media viewing object, a speaker 4 is located right behind the media viewing object, and a speaker 5 is located right above the media viewing object. Different virtual speakers in the stereo speaker system are responsible for rendering audio signals of different channels. Because one channel corresponds to a different spatial position of a speaker in the media playback scene, the N channels shown in FIG. 2 specifically include: five channels of a left channel (L), a right channel (R), a center channel (C), a back channel (B), and a high channel (H). Therefore, the speaker 1 is responsible for rendering an audio signal on the left channel, the speaker 2 is responsible for rendering an audio signal on the right channel, . . . , and the speaker 5 is responsible for rendering an audio signal on the high channel, so that each virtual speaker renders an audio signal on a respective channel, and rendered audio signals come from different directions in the media playback scene, thereby creating immersive sound effect experience of stereo and spatial quality played from different directions and positions.

A virtual speaker (ModelEntity) refers to a speaker that is virtual (that is, not a speaker that can be actually perceived by a user). The speaker refers to a device having an audio playback capability, that is, a device that can make sound. Therefore, the virtual speaker in some embodiments refers to a virtual device having an audio playback capability, and can render and play an audio signal of a corresponding channel. Speaker attributes (a geometric shape, a material, and a color) of the virtual speakers in the stereo speaker system may be the same or different. For example, the speaker 1 may be circular, and the speaker 2 may be rectangular. Alternatively, each of the speakers is circular.

### 4. RealityKit Technology.

In some embodiments, a rendering framework (for example, a RealityKit framework) may be used to arrange N virtual speakers in the media playback scene and perform audio rendering. The RealityKit framework is a set of high-performance rendering and animation frameworks, aiming to simplify a development process of an augmented reality (AR) application program, and provide powerful tools and functions to implement high-quality visual, auditory, and interactive experience. In some embodiments, RealityKit mainly has the following functions:

Function 1. User-define a material and a special effect: a developer may define a material, a mesh, a color, and a special effect for a virtual speaker application by using RealityKit, so as to create a more vivid and personalized visual effect.

Function 2. Environment understanding: RealityKit may obtain data from a sensor of a media playback device, such as a camera, a LIDAR, and a gyroscope, to help an application program understand and interact with a real world environment. In some embodiments, the virtual speaker can detect a moving status of a media viewing object in a media playback scene in real time based on the RealityKit technology, and after a position of the media viewing object moves, update a spatial position of the virtual speaker in real time to match the spatial position of the media viewing object, so that audio playback can be performed according to the new spatial position, thereby implementing an audio playback capability of moving as the user moves in an audio playback process.

In addition, in the audio processing solution provided in some embodiments, the following two points further need to be described:
(1) Related data (for example, a multi-channel media audio and audio data) in an audio processing process in some embodiments. In some embodiments, when the foregoing embodiment is applied to a specific product or technology, permission or consent of the object needs to be obtained, and relevant data collection, use, and processing need to comply with relevant laws, regulations and standards, comply with a principle of legality, legitimacy, and necessity, and not involve obtaining of a data type prohibited or restricted by the laws and regulations. In some embodiments, the relevant data involved is obtained after obtaining individual authorization from the object. Furthermore, when obtaining such individual authorization, the intended use of the relevant data is clearly disclosed to the object.
(2) The terms such as “first” and “second” are intended to distinguish same items or similar items with substantially same effects and functions. The “first”, “second”, and “n^{th}” do not have a dependency relationship in logic or time sequence, and a quantity and an execution order are not limited.

The following describes details of an audio processing system according to some embodiments.

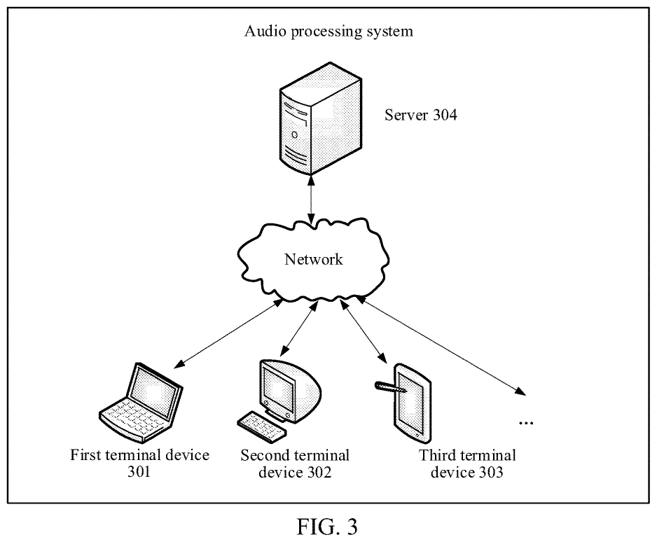

Referring to FIG. 3, FIG. 3 is a schematic architectural diagram of an audio processing system according to one or more embodiments. As shown in FIG. 3, the architectural diagram of the audio processing system can include at least: a server 304 and a terminal device cluster. The terminal device cluster includes: multiple terminal devices such as a first terminal device 301, a second terminal device 302, and a third terminal device 303, and any terminal device has an audio playback capability. A quantity of terminal devices included in the terminal device cluster is merely used for an example, and the number and types of the terminal devices are not limited herein. Any terminal device in the terminal device cluster may be directly or indirectly connected to the server 304 through a network. The network may include, but is not limited to, a wired network and a wireless network. The wired network includes: a local area network, a metropolitan area network, and a wide area network. The wireless network includes: Bluetooth, wireless fidelity (WI-FI), and another network implementing wireless communication.

In the audio processing system shown in FIG. 3, each terminal device in the terminal device cluster may be: a mobile phone, a tablet computer, a notebook computer, a desktop computer, a game device, an in-vehicle device, an aircraft, a wearable device (an intelligent device such as a smartwatch, a smart band, or a pedometer), a smart appliance, or an extended reality (XR) device. For example, the XR device includes a virtual reality (for example, a virtual reality (VR) device or an augmented reality (AR) device), a mixed reality (MR) device, or the like. Types of the terminal devices in the terminal device cluster may be the same or different. For example, the first terminal device 301 may be a notebook computer, the second terminal device 302 may be a desktop computer, and the third terminal device 303 may be a tablet computer. The disclosure does not impose a limitation on the quantity and types of the terminal devices in the terminal device cluster. The server 304 may be an independent physical server, or a server cluster or distributed system composed of multiple physical servers, or a cloud server providing basic cloud computation services such as a cloud service, a cloud database, cloud computation, a cloud function, cloud storage, network service, cloud communication, middleware service, domain name service, security service, a content delivery network (CDN), big data, and an artificial intelligence platform.

Next, any terminal device (for example, the first terminal device 301) in the audio processing system is used as an example to correspondingly describe a data interaction process between the first terminal device 301 and the server 304 in the media playback scene.

\textcircled{1} In a media playback scene (for example, a movie watching scene or a game watching scene), the first terminal device 301 may obtain a to-be-processed multi-channel audio signal source in the media playback scene, and send the multi-channel audio signal source to the server 304. The multi-channel audio signal source includes K multi-channel audio frames, each multi-channel audio frame is formed by audio signals collected by N channels, each channel corresponds to a different spatial position in a media playback scene, N is an integer greater than 1, and K is a positive integer.

\textcircled{2} The server 304 performs format resampling processing (for example, by using a channel segmentation technology) on the multi-channel audio signal source, to perform signal segmentation on each multi-channel audio frame according to different channels, to obtain a to-be-played multi-channel media audio, and sends the multi-channel media audio to the first terminal device 301.

\textcircled{3} The first terminal device 301 obtains a target spatial position of the media viewing object in the media playback scene. For example, the target spatial position is three-dimensional space coordinates of the media viewing object.

\textcircled{4} The first terminal device 301 arranges the stereo speaker system around the target spatial position in the media playback scene based on the target spatial position. The stereo speaker system includes N virtual speakers, and a deployment position of each virtual speaker in the media playback scene matches a spatial position of a channel in the media playback scene. That is, when the virtual speaker is deployed, a spatial position of the speaker during signal collection is recovered as much as possible. In this way, the stereo speaker system can be deployed around the media viewing object according to a real-time position of the media viewing object.

\textcircled{5} The first terminal device 301 performs multi-channel audio rendering processing on the multi-channel media audio by using the stereo speaker system, and plays, by using the stereo speaker system, the multi-channel media audio on which the multi-channel audio rendering processing is performed. Virtual speakers in the stereo speaker system separately perform audio rendering processing on audio signals collected on matching channels, so that the virtual speaker can be independently responsible for rendering audio signals at corresponding directional positions, and jointly create an immersive audio playback effect for a media viewing object.

The above audio processing process is merely used as an example, and does not limit specific execution processes of the terminal device and the server. In an embodiment, the terminal device may send the target spatial position and the multi-channel media audio to the server, and the server determines a deployment position of each virtual speaker that needs to be deployed in the stereo speaker system, then the server sends a specific deployment position of each virtual speaker in the stereo speaker system in the media playback scene to the terminal device, and then the terminal device executes a process of deploying the stereo speaker system in the media playback scene. Alternatively, a complete process of the audio processing may be performed by any terminal device or the server alone in the audio processing system.

In a possible implementation, the audio processing system according to some embodiments may be deployed on a node of a blockchain. For example, the first terminal device 301, the second terminal device 302, the third terminal device 303, and the server 304 may be used as node devices of the blockchain, to jointly form a blockchain network. Therefore, in some embodiments, an audio processing process may be performed on the blockchain. In this way, fairness of the audio processing process can be ensured. Meanwhile, the process can be traceable, and data security during audio processing can be ensured, thereby improving security and reliability of the entire audio processing process.

The audio processing system provided in some embodiments is configured to perform the above audio processing solution. In some embodiments, in a process of deploying the stereo speaker system, virtual recovery can be performed on a spatial position of the multi-channel media audio during collection, and the stereo speaker system can be deployed around the media viewing object based on a real-time position of the media viewing object, so that a real sound environment of the media audio can be recovered as much as possible in the media playback scene, thereby improving realness of an audio playback effect. In some embodiments, N virtual speakers are configured to separately render audio signals collected by N channels, so that a rendering effect of the multi-channel spatial rendering can be achieved, thereby improving immersive experience in the media playback scene.

The audio processing system described herein is intended to describe the technical solutions in one or more embodiments more clearly, and does not constitute a limitation on the technical solutions. A person of ordinary skill in the art may learn that with the evolution of a system architecture and emergence of new service scenarios, the technical solutions provided in the embodiments of the disclosure are also applicable to similar technical problems.

Specific embodiments related to an audio processing solution in the disclosure are described in detail below with reference to the accompanying drawings.

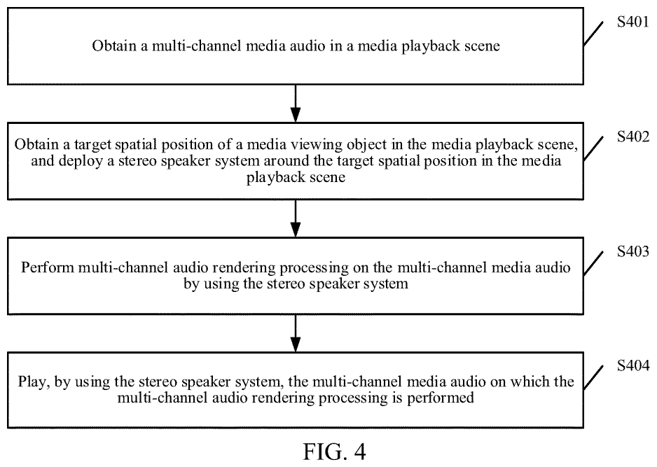

Referring to FIG. 4, FIG. 4 is a schematic flowchart of an audio processing method according to one or more embodiments. The audio processing method may be performed by a computer device (any terminal device or the server shown in FIG. 3). As shown in FIG. 4, the audio processing method includes, but is not limited to, the following operations S401 to S404:
S401: Obtain a multi-channel media audio in a media playback scene.

The multi-channel media audio includes audio signals collected by using N channels, each channel corresponds to a different spatial position in the media playback scene, and N is an integer greater than 1. The audio signals of the different channels are collected simultaneously, that is, within the same time period, signal lengths of the audio signals collected for the different channels are the same. For example, in a process of signal collection by using the left channel and the right channel, within one minute, a left channel audio signal whose signal length is one minute may be collected, and at the same time, a right channel audio signal whose signal length is one minute is collected.

In an embodiment, signal processing needs to be further performed on a multi-channel media audio collected by using N channels. The signal processing herein includes but is not limited to at least one of resampling processing and audio preprocessing. Based on this, a signal processing process of a multi-channel media audio is described in detail below:

### 1. Perform Resampling Processing on a Collected Multi-Channel Audio Signal Source.

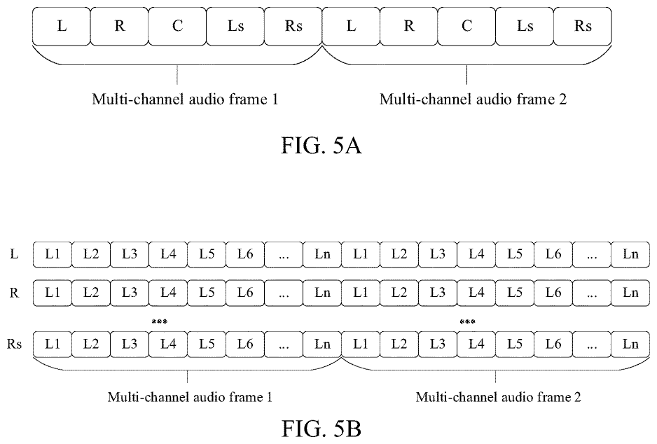

In a possible implementation, the multi-channel media audio includes N pieces of audio data. Specifically, a process of obtaining a multi-channel media audio includes the following operations (1) to (3):
(1) Obtain a collected multi-channel audio signal source in the media playback scene. The multi-channel audio signal source is generated after signal collection is performed by using N channels, and each channel corresponds to a different spatial position in a media playback scene. Therefore, the collected multi-channel audio signal source is a multi-channel mixed audio signal, that is, each audio frame includes audio signals of multiple channels.
(2) Perform framing processing on the multi-channel audio signal source, to obtain K multi-channel audio frames, where each multi-channel audio frame is formed by audio signals of N channels, and K is a positive integer. Specifically, framing processing may be performed on the multi-channel audio signal source according to a preset frame length (for example, 2.5 ms to 60 ms), to obtain K multi-channel audio frames. Referring to FIG. 5A, FIG. 5A is a schematic structural diagram of a multi-channel audio signal source according to one or more embodiments. As shown in FIG. 5A, it is assumed that the N channels include five channels: a left channel (L), a right channel (R), a center channel (C), a left surround channel (Ls), and a right surround channel (Rs). Because audio signals of the N channels are collected at the same time in a signal collection process, each multi-channel audio frame includes audio signals of the N channels. For example, a multi-channel audio frame 1 (Frame1) includes audio signals of five channels: L, R, C, Ls, and Rs. For another example, a multi-channel audio frame 2 (Frame2) also includes audio signals of five channels: L, R, C, Ls, and Rs.
(3) Perform format resampling processing on the multi-channel audio signal source by using a channel segmentation technology, to perform signal segmentation on each multi-channel audio frame according to different channels, to obtain N pieces of audio data; where any one piece of audio data includes K audio frames, K audio frames included in one piece of audio data all belong to the same channel, and K is a positive integer; where the channel segmentation technology includes: any one of audio editing software, an audio segmentation tool, and an audio processing framework. Specifically, \textcircled{1} the audio editing software may be, for example, an open-source audio editor Audacity, and sound track splitting may be performed on a multi-channel audio signal source by using the audio editor Audacity, to obtain multiple pieces of audio data of a single channel. \textcircled{2} An audio segmentation tool refers to a tool (for example, an FFmpeg command) having a channel segmentation function for an audio signal, and sound track splitting may be performed on a multi-channel audio signal source by invoking the FFmpeg command, to obtain audio data of N channels. \textcircled{3} The audio processing framework may be a Librosa framework. The Librosa framework is a Python library used for audio analysis, and may also implement a function of performing channel segmentation on an audio signal. In an actual application, a suitable channel segmentation technology may be selected according to a specific scenario requirement to perform channel segmentation, so as to improve a segmentation effect.

Specifically, because this interleaved-sample audio signal combining manner shown in FIG. 5A makes it inconvenient to extract audio data of each channel, an audio frame format needs to be resampled and converted into a planar combining manner, that is, an audio signal of each channel is independently stored. Based on this, referring to FIG. 5B, FIG. 5B is a schematic structural diagram of a multi-channel media audio according to one or more embodiments. As shown in FIG. 5B, after format resampling is performed on the multi-channel audio signal source by using the channel segmentation technology, audio data of each channel can be conveniently obtained, to perform rendering and playback in the channels without interference from each other.

According to the process shown in operation (1) to operation (3), after format resampling processing is performed on the multi-channel audio signal source, the audio signals of the N channels can be separately stored, so that the audio signals of the channels can be independently processed subsequently.

### 2. Perform Audio Preprocessing on a Collected Multi-Channel Audio Signal Source.

In a possible implementation, audio preprocessing is performed on the multi-channel audio signal source, to obtain a preprocessed multi-channel audio signal source. Format resampling processing is performed on the preprocessed multi-channel audio signal source by using a channel segmentation technology, to obtain N pieces of audio data (a specific process of format resampling is described in the above process). The audio preprocessing includes any one or more of echo cancellation processing, noise suppression processing, normalization processing, and voice activity detection. Specifically, \textcircled{1} echo cancellation: a technology used for cancelling an echo. When sound played by a speaker is picked up again by a microphone and is transmitted back to the other party, an echo is generated. \textcircled{2} Noise suppression: a technology used for reducing background noise or ambient noise, and usually used for improving voice communication quality. \textcircled{3} Voice activity detection (VAD): a technology used for detecting whether a live audio signal exists in a multi-channel media audio, to improve audio processing efficiency. By using the foregoing audio preprocessing manner, a collected multi-channel audio signal source can be optimized in advance, thereby improving audio quality of a multi-channel media audio that needs to be played, so as to improve an audio playback effect.
S402: Obtain a target spatial position of a media viewing object in the media playback scene, and deploy a stereo speaker system around the target spatial position in the media playback scene.

The multi-channel media audio is generated by using N channels by means of signal collection, and each channel corresponds to a different spatial position in the media playback scene. It can be seen that the multi-channel media audio is obtained by N physical speakers at N spatial positions in the media playback scene by means of signal collection; therefore, N virtual speakers need to be deployed in the stereo speaker system to virtually recover a speaker deployment during a signal collection process. That is, the stereo speaker system includes N virtual speakers, and a deployment position of each virtual speaker in the media playback scene matches a spatial position of a channel in the media playback scene. The matching herein includes: a deployment position of the virtual speaker is the same as a corresponding spatial position during signal collection. Alternatively, a distance between the deployment position of the virtual speaker and a corresponding spatial position during signal collection is within a specified preset threshold. That is, in some embodiments, when deploying the stereo speaker system, a speaker deployment (that is, a spatial position in the media playback scene) during signal collection can be virtually recovered as much as possible, thereby improving reality and accuracy of multi-channel audio playback.

In a possible implementation, a manner of obtaining the target spatial position of the media viewing object in the media playback scene includes the following two manners: Manner 1: The media viewing object in the media playback scene may be detected by using a sensor, to obtain the target spatial position of the media viewing object in the media playback scene. Manner 2: The media viewing object is detected in the media playback scene by using an infrared detector, and the target spatial position of the media viewing object in the media playback scene is automatically obtained. The target spatial position herein may be represented by using three-dimensional coordinates (x, y, z). There may be one or more media viewing objects in the media playback scene. If there are multiple media viewing objects, respective target spatial positions of the media viewing objects in the media playback scene need to be obtained. For ease of description, in some embodiments, one media viewing object is used as an example for description.

During specific implementation, a process of deploying the stereo speaker system around the target spatial position in the media playback scene is as follows: (1) Determine deployment information of each virtual speaker in the stereo speaker system based on the target spatial position, where the deployment information herein includes, for example, one or more of a deployment position, a direction, and a speaker attribute. (2) Deploy the stereo speaker system in the media playback scene according to the deployment information (for example, a deployment position and a direction) of each virtual speaker. The stereo speaker system deployed in some embodiments is a virtual reality system (that is, a VR system) in a media playback scene. The VR system is a computer simulation system that can create and experience a virtual world. The VR system generates a simulation environment in the media playback scene by using a VR technology, to provide a user (for example, a media viewing object) with visual, auditory, and tactile simulation and the like, so that the user can observe an object in a three-dimensional space in time without limitation in the media playback scene, thereby bringing immersive experience to the user in the media playback scene. Although the stereo speaker system is a virtual reality system, the stereo speaker system has an audio rendering capability and an audio playback capability for a multi-channel media audio (an audio signal including multiple channels).

In some embodiments, the stereo speaker system may be deployed around the target spatial position in the media playback scene. A deployment manner of the stereo speaker system mainly includes the following two manners: 1. Deploy the stereo speaker system according to a preset unified speaker deployment standard. 2. Deploy a matching stereo speaker system according to a type of a multi-channel media audio. The following describes in detail two different deployment manners of deploying the stereo speaker system:

Manner 1: Deploy the stereo speaker system according to a preset unified speaker deployment standard.

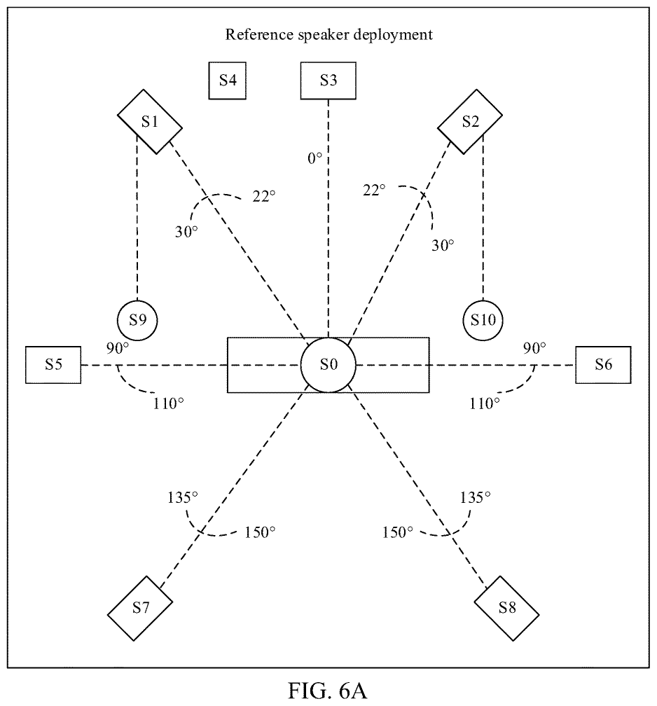

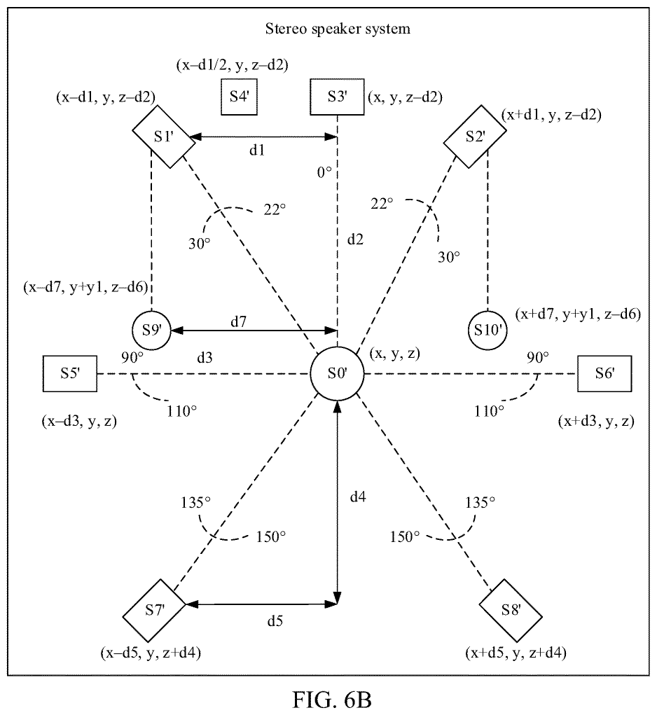

In a possible implementation, the multi-channel media audio is obtained by collecting audio signals by using N physical speakers; and one physical speaker is configured to collect an audio signal of one channel at one spatial position of the media playback scene. Specifically, the deploying a stereo speaker system around the target spatial position in the media playback scene includes the following operations (1) and (2):
(1) Analyze the multi-channel media audio, and determine a reference speaker deployment of the N physical speakers in a signal collection process, where the reference speaker deployment includes: a distance and a direction between each physical speaker and a reference spatial position in the media playback scene. Specifically, in a signal collection process, a reference spatial position first needs to be disposed, and then spatial positions and deployment directions of N physical speakers for signal collection are disposed around the reference spatial position by using the reference spatial position as the center. Referring to FIG. 6A, FIG. 6A is a schematic structural diagram of a reference speaker deployment according to one or more embodiments. As shown in FIG. 6A, a reference spatial position may be a spatial position of a space point S0 in a three-dimensional (3D) space, and at a space point S1, signals are collected by N physical speakers arranged around, to obtain a multi-channel media audio. It is assumed that a reference speaker deployment is used to indicate: 10 physical speakers are used to collect signals, and spatial positions of the 10 physical speakers deployed in a signal collection process are shown in FIG. 6A: S1, S2, S3, . . . , and S10. S1 refers to a left speaker, S2 refers to a right speaker, S3 refers to a center speaker, S4 refers to a low frequency effect speaker, S5 refers to a left surround speaker, S6 refers to a right surround speaker, S7 refers to a left surround back speaker, S8 refers to a right surround back speaker, S9 refers to a height left center speaker, and S10 refers to a height right center speaker. In addition, a distance and a direction between each physical speaker and the reference spatial position (S0) can be determined according to the reference speaker deployment. For example, the distance between the left speaker S1 and the reference spatial position (S0) is D1, and the direction is a first direction. For example, the left speaker S1 is located at a spatial position that is away from the upper left side of the reference spatial position S0 by D1 and is in a 30° direction. For another example, the right speaker S2 is located at a spatial position that is away from the upper right side of the reference spatial position S0 by D1 and is in a 30° direction. Based on this, after signal collection is performed according to the reference preset deployment shown in FIG. 6A, a multi-channel media audio can be obtained. Then, after the multi-channel media audio is analyzed, a detailed deployment (the reference speaker deployment) of each physical speaker during signal collection of the multi-channel media audio can be recovered.
(2) Deploy the stereo speaker system in the media playback scene based on the target spatial position and the reference speaker deployment. The target spatial position may be represented by using three-dimensional space coordinates (x, y, z), any of the N physical speakers is represented as a physical speaker a, and a is a positive integer and 1≤a≤N. The distance between the physical speaker a and the reference spatial position includes: a first distance d1, a second distance d2, and a third distance d3. During speaker deployment, a specific deployment may be performed according to three-dimensional space coordinates. Then, a first distance herein refers to a lateral distance (an x-axis distance) between the physical speaker a and the reference spatial position S0, a second distance refers to a longitudinal distance (a y-axis distance) between the physical speaker a and the reference spatial position S0, and a third distance refers to a spatial distance (a z-axis distance) between the physical speaker a and the reference spatial position S0. Therefore, a process of deploying any virtual speaker is as the following \textcircled{1} and \textcircled{2}:
\textcircled{1} Calculate a candidate position (x′, y′, z′) of a to-be-deployed virtual speaker b based on the target spatial position (x, y, z), the first distance d1, the second distance d2, and the third distance d3 between the physical speaker a and the reference spatial position. During specific implementation, according to the reference speaker deployment standard shown in FIG. 6A, if the target spatial position and a distance between a to-be-deployed virtual speaker and the target spatial position are known, three-dimensional deployment coordinates (x′, y′, z′) of each to-be-deployed virtual speaker may be determined.

Referring to FIG. 6B, FIG. 6B is a schematic structural diagram of deployment of a stereo speaker deployment system according to one or more embodiments. As shown in FIG. 6B, using a 10-channel speaker deployment shown in FIG. 6A as an example (that is, 10 physical speakers), coordinates of a target spatial position S0′ are represented as (x, y, z). Therefore, according to distances between the virtual speakers and the target spatial position and the reference speaker deployment, three-dimensional space coordinates of each to-be-deployed virtual speaker may be calculated as follows: a left speaker S1′: (x−d1, y, z−d2), a right speaker S2′: (x+d1, y, z−d2), a center speaker S3′: (x, y, z−d2), a low frequency effect speaker S4′: (x−d1/2, y, z−d2), a left surround speaker S5′: (x−d3, y, z), a right surround speaker S6′: (x+d3, y, z), a left surround back speaker S7′: (x−d5, y, z+d4), a right surround back speaker S8′: (x+d5, y, z+d4), a height left central speaker S9′: (x−d7, y+y1, z−d6), and a height right central speaker S10′: (x+d7, y, z−d6).
\textcircled{2} Deploy the virtual speaker b in the media playback scene based on the candidate position (x′, y′, z′) of the virtual speaker b and the direction of the physical speaker a in the media playback scene. In an embodiment, deploying a virtual speaker b needs to include the following deployment information: a spatial position, a direction, and a speaker attribute (an attribute such as a geometrical shape or a material). A process of determining the deployment information of the virtual speaker is as follows:
I. Spatial position. The to-be-deployed spatial position of the virtual speaker b in the media playback scene includes the following two cases: Case 1. A candidate position (x′, y′, z′) of the virtual speaker b may be directly used as a to-be-deployed spatial position of the to-be-deployed virtual speaker b in the media playback scene. Case 2. The virtual speaker b may be deployed within a particular range around the candidate position (x′, y′, z′), that is, a to-be-deployed spatial position of the virtual speaker b in the media playback scene is determined based on the candidate position (x′, y′, z′). A distance between the to-be-deployed spatial position and the candidate position is less than a preset threshold.
II. Direction. The direction of the physical speaker a in the media playback scene may be determined as a to-be-deployed direction of the virtual speaker b in the media playback scene, that is, the deployment direction of the speaker remains unchanged.
III. Speaker attribute. A speaker attribute may be set for the virtual speaker b. The speaker attribute herein includes: any one or more of a geometric shape (for example, any shape such as circular, rectangular, or elliptical) and a material (for example, metal or plastic).

Based on this, one virtual speaker b may be deployed in the media playback scene according to the to-be-deployed spatial position, the to-be-deployed direction, and the speaker attribute. For example, the virtual speaker b is deployed in the media playback scene by using the RealityKit technology. Based on this, according to the foregoing manner, N virtual speakers can be deployed in the media playback scene to form the stereo speaker system (shape and material attributes of the N virtual speakers may be the same or different). Because each to-be-deployed virtual speaker may be adaptively deployed with reference to the preset speaker deployment standard shown in FIG. 6A, a deployment position of each deployed virtual speaker in the media playback scene matches a spatial position of a channel in the media playback scene, so that the speaker deployment standard during signal collection can be recovered as much as possible.

Based on operations (1) and (2) shown in manner 1, in some embodiments, based on a preset deployment standard of each physical speaker during signal collection, a speaker deployment can be virtually recovered according to a real-time position of a media viewing object, so as to deploy a stereo speaker system around the media viewing object, to recover a deployment standard in a real sound environment as much as possible, thereby improving realness and accuracy of a subsequent audio playback effect.

Manner 2. Deploy a matching stereo speaker system according to a type of a multi-channel media audio.

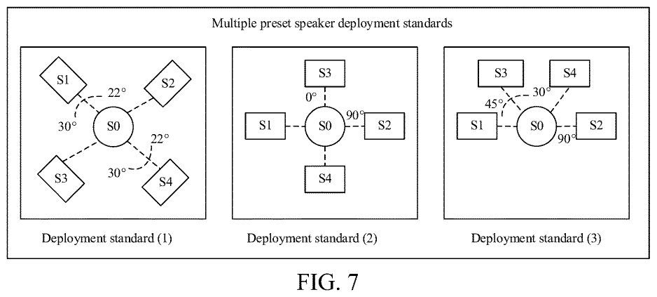

In a possible implementation, a specific process of deploying a matching stereo speaker system according to a type of a multi-channel media audio is as the following (1) to (4):
(1) Analyze the multi-channel media audio, and determine an audio type of the multi-channel media audio. For example, audio types of the multi-channel media audio include: a first type, a second type, and a third type. The first type refers to a type corresponding to movie media, the second type refers to a type corresponding to game media, and the third type refers to a type corresponding to pure audio media.
(2) Obtain multiple corresponding multi-channel speaker deployments in the media playback scene; where any one of the multi-channel speaker deployments is configured to specify spatial deployment information of the N physical speakers in a signal collection process. For example, in some embodiments, multiple speaker deployment standards may be preset. Referring to FIG. 7, FIG. 7 is a schematic diagram of a multi-channel speaker deployment according to one or more embodiments. As shown in FIG. 7, it is assumed that a four-channel speaker deployment system is used as an example (that is, there are four speakers). Some embodiments provide three multi-channel speaker deployment standards: a speaker deployment standard 1, a speaker deployment standard 2, and a speaker deployment standard 3. Each speaker deployment standard includes deployment positions and directions of N (four) physical speakers used for signal collection. For example, the speaker deployment standard 1 includes: four speakers S1, S2, S3, and S4 that are deployed on top left, top right, bottom left, and bottom right. The speaker deployment standard 2 includes: four speakers S1, S2, S3, and S4 that are deployed on the left, right, top, and bottom. The speaker deployment standard 3 includes: four speakers S1, S2, S3, and S4 that are deployed on the left, right, upper left, and upper right. It can be learned that deployment positions and directions of speakers defined by different speaker deployment standards are different.
(3) Determine, based on the audio type, a multi-channel speaker deployment matching the audio type from the multiple multi-channel speaker deployments, and use the determined multi-channel speaker deployment as the reference speaker deployment. For example, if the audio type is the first type, the speaker deployment standard 1 is used as a reference speaker deployment. For another example, if the audio type is the second type, the speaker deployment standard 2 is used as a reference speaker deployment. For another example, if the audio type is the third type, the speaker deployment standard 3 is used as a reference speaker deployment.
(4) Deploy the stereo speaker system in the media playback scene based on the target spatial position and the reference speaker deployment. Specifically, For details of a specific process of performing this operation, refer to the detailed process shown in operation (2) in manner 1, and details are not described herein again.

Based on operations (1) to (4) shown in manner 2, in some embodiments, a best matching speaker deployment standard can be selected from multiple speaker deployment standards as a reference speaker deployment according to the type of the multi-channel media audio, and the speaker deployment is virtually recovered according to the real-time position of the media viewing object. This manner can further improve the accuracy of the speaker deployment, to achieve a more vivid speaker deployment effect.

Based on this, each physical speaker may be abstracted as a ModelEntity (that is, a virtual speaker) based on the multi-channel media audio collected by the N physical speakers by using a RealityKit technology. The ModelEntity of the virtual speaker not only can be used as a sound source in a media playback scene, but also a spatial position of the virtual speaker can be determined by setting three-dimensional position coordinates of the ModelEntity. In addition, speaker attributes such as a geometrical shape, a mesh, a material, and a color of the ModelEntity may also be user-defined. For example, the physical speakers may be abstracted into blue spherical virtual speakers, and after space deployment is performed according to the foregoing placement algorithm, a virtual 5.1 space speaker system (a stereo speaker system) may be formed. A virtual speaker of each ModelEntity is only responsible for rendering an audio signal of a corresponding direction position without affecting rendering of other speakers, to jointly create more spatially immersive auditory experience.
S403: Perform multi-channel audio rendering processing on the multi-channel media audio by using the stereo speaker system.

Multi-channel audio rendering processing is a rendering process of using N virtual speakers already deployed in a stereo speaker system, to render a multi-channel media audio collected by N channels. One virtual speaker is configured to render an audio signal collected on one channel. For example, the left speaker is configured to render an audio signal collected on a left channel, and the right speaker is configured to render an audio signal collected on a right channel. The left channel and the right channel herein are determined relative to a position of a media viewing object, the left channel is a spatial position corresponding to a left direction of the media viewing object, and similarly, the right channel is a spatial position corresponding to a right direction of the media viewing object. In addition, rendering processing includes, but is not limited to, sound effect processing, volume processing, digital-to-analog conversion processing (for example, converting a digital signal into an analog signal), and the like. A rendered multi-channel media audio may be played by using a stereo speaker system.

Each virtual speaker in the stereo speaker system performs audio rendering processing on an audio signal collected by a matching channel. Specifically, the multi-channel media audio includes N pieces of audio data, and one piece of audio data is an audio signal collected by one channel, that is, each audio data corresponds to a channel. Therefore, each virtual speaker in the stereo speaker system may perform audio rendering processing on an audio signal (that is, one piece of audio data) of one channel. For example, the left speaker is configured to render an audio signal of a left channel (L), the right speaker is configured to render an audio signal of a right channel (R), the center speaker is configured to render an audio signal of a center channel (C), . . . , and so on. The N virtual speakers in the stereo speaker system separately perform independent rendering on audio signals of respective channels, and can jointly implement a multi-channel audio rendering effect while not interfering with each other.

In a possible implementation, a process of performing multi-channel audio rendering processing on a multi-channel media audio by using a stereo speaker system (that is, N virtual speakers) is as follows: (1) parse the multi-channel media audio, and determine a channel corresponding to each piece of audio data; (2) obtain a channel deployment association rule, where the channel deployment association rule defines that: each of the N virtual speakers is associated with one of the N channels; and (3) perform audio rendering processing on the N pieces of audio data for the N channels by using N virtual speakers based on the channel deployment association rule and a channel corresponding to each audio frame; where one virtual speaker is configured to perform rendering processing on audio data of one channel. In this implementation, each virtual speaker performs independent rendering processing on an audio signal of a respective channel, and can jointly implement a multi-channel audio rendering effect while not interfering with each other.
S404: Play, by using the stereo speaker system, the multi-channel media audio on which the multi-channel audio rendering processing is performed.

Specifically, after each virtual speaker performs rendering processing on an audio signal of a corresponding channel that the speaker is responsible for rendering, the audio signal obtained after the audio rendering may be played at a corresponding directional position in the media playback scene. In this way, the N virtual speakers may jointly create a stereo surround sound effect after multi-channel (N-channel) rendering, that is, a stereo surround play effect of the multi-channel media audio around a media viewing object can be achieved in a media playback scene. For example, a media playback scene shown in FIG. 1 is: bird song at a valley in front of eyes, breeze above the head, lingering music behind, Guzheng and bell sound. This presents, based on an audio-visual synchronization manner, a poetic and gigantic Chinese-style scene, and bring immersive audio-visual experience to a media viewing object.

Because the stereo speaker system is deployed around the media viewing object, and when deploying the stereo speaker system, virtual restoration is performed as much as possible according to a spatial position of a multi-channel media audio during collection, to determine a deployment position of a virtual speaker. For example, a left channel audio signal collected by using a left channel in the multi-channel media audio is deployed as a virtual speaker on a left channel, and the deployment position of the virtual speaker on the left channel matches a corresponding spatial position of the left channel in a media playback scene. Similarly, a right channel audio signal collected by using a right channel in the multi-channel media audio is deployed as a virtual speaker on a right channel, and the deployment position of the virtual speaker on the right channel matches a corresponding spatial position of the right channel in a media playback scene, and so on, so that in the media playback scene, a real sound environment of the media audio can be recovered as much as possible, thereby improving realness of an audio playback effect.

In some embodiments, an audio processing method is provided. When deploying the stereo speaker system, the method aims to recover a spatial position of a speaker during signal collection as far as possible, thereby achieving a rendering effect of the multi-channel spatial audio and improving immersive experience in the media playback scene. In some embodiments, in a process of deploying the stereo speaker system, virtual recovery can be performed on a spatial position of the multi-channel media audio during collection, and the stereo speaker system can be deployed around the media viewing object based on a real-time position of the media viewing object, so that a real sound environment of the media audio can be recovered as much as possible in the media playback scene, thereby improving realness of an audio playback effect. In some embodiments, N virtual speakers are configured to separately render audio signals collected by N channels, so that a rendering effect of the multi-channel spatial rendering can be achieved, thereby improving immersive experience in the media playback scene.

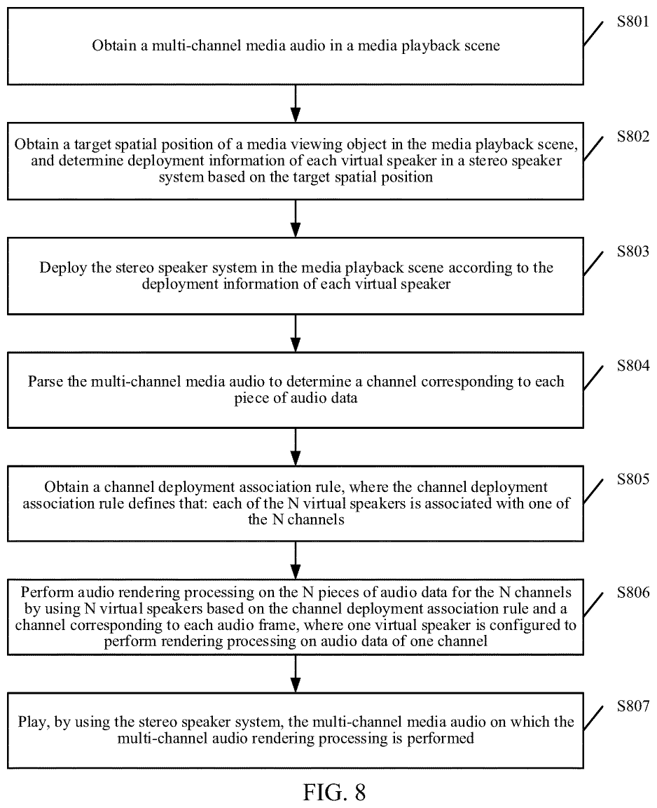

Referring to FIG. 8, FIG. 8 is a schematic flowchart of another audio processing method according to one or more embodiments. The audio processing method may be performed by a computer device (any terminal device or server shown in FIG. 3). As shown in FIG. 8, the audio processing method may include, but is not limited to, the following operations S801 to S807:
S801: Obtain a multi-channel media audio in a media playback scene.

The multi-channel media audio includes audio signals collected by using N channels, each channel corresponds to a different spatial position in the media playback scene, and N is an integer greater than 1.

In a possible implementation, a process of obtaining a multi-channel media audio is as follows: obtaining a collected multi-channel audio signal source in a media playback scene; performing framing processing on the multi-channel audio signal source, to obtain K multi-channel audio frames, where each multi-channel audio frame is formed by audio signals of N channels; and performing format resampling processing on the multi-channel audio signal source by using a channel segmentation technology, to perform signal segmentation on each multi-channel audio frame according to different channels, to obtain N pieces of audio data; where any one piece of audio data includes K audio frames, K audio frames included in one piece of audio data all belong to the same channel, and K is a positive integer; where the channel segmentation technology includes: any one of audio editing software, an audio segmentation tool, and an audio processing framework. For details of a specific processing process of the multi-channel media audio in some embodiments, refer to a related process in operation S401 in the embodiment in FIG. 4, and details are not described herein again.
S802: Obtain a target spatial position of a media viewing object in the media playback scene, and determine deployment information of each virtual speaker in a stereo speaker system based on the target spatial position.

The stereo speaker system includes N virtual speakers, and a deployment position of each virtual speaker in the media playback scene matches a spatial position of a channel in the media playback scene. In addition, the matching herein specifically includes: a deployment position of the virtual speaker is the same as a corresponding spatial position during signal collection. Alternatively, a distance between the deployment position of the virtual speaker and a corresponding spatial position during signal collection is within a specified preset threshold. That is, in some embodiments, when deploying the stereo speaker system, a speaker deployment (that is, a spatial position in the media playback scene) during signal collection is virtually recovered as much as possible, thereby improving reality and accuracy of multi-channel audio playback.

In a possible implementation, the deployment information of each virtual speaker includes: any one or more of a deployment position, a direction, and a speaker attribute. The speaker attribute includes: a geometric shape (for example, circular, rectangular, or polygonal), a material (for example, metal or plastic), a color (for example, white or blue), and the like. Specifically, the determining deployment information of each virtual speaker (for example, a virtual speaker b) in the stereo speaker system based on the target spatial position specifically includes the following operations (1) to (3):
(1) Analyze the multi-channel media audio, and determine a reference speaker deployment of the N physical speakers in a signal collection process, where the reference speaker deployment includes: a distance and a direction between each physical speaker and a reference spatial position in the media playback scene.
(2) Calculate a candidate position (x′, y′, z′) of a to-be-deployed virtual speaker b based on the target spatial position (x, y, z), the first distance d1, the second distance d2, and the third distance d3 between the physical speaker a and the reference spatial position.
(3) Deploy the virtual speaker b in the media playback scene based on the candidate position (x′, y′, z′) of the virtual speaker b and the direction of the physical speaker a in the media playback scene.

Based on the foregoing operations (1) to (3), in some embodiments, the deployment information of each to-be-deployed virtual speaker can be determined. Because the multi-channel media audio is obtained after N physical speakers collect signals of N channels in the media playback scene, N virtual speakers need to be deployed, and deployment information of each virtual speaker may be determined and processed in the foregoing manner, so that the deployment information of the N virtual speakers can be obtained.
S803: Deploy the stereo speaker system in the media playback scene according to the deployment information of each virtual speaker.

For a process of determining the deployment information of each virtual speaker, refer to the process shown in operation S802, and then deployment information (for example, deployment positions, directions, and speaker attributes) of the to-be-deployed N virtual speakers may be determined. In an embodiment, speaker attributes (for example, geometric shapes, materials, and colors) of the N virtual speakers may be the same or different. For example, the N virtual speakers are all blue circular entities. For another example, some virtual speakers are blue circular entities, and other virtual speakers are blue rectangular entities. For another example, some virtual speakers are white circular entities, and other virtual speakers are blue rectangular entities. Specific attributes of the virtual speakers are not limited in some embodiments. In an actual application, corresponding speaker attributes may be self-defined according to requirements, to satisfy flexible user requirements.

For a detailed process of operations S802 and S803 in some embodiments, refer to a related process of operation S402 in the foregoing embodiment, and details are not described herein again.

A specific process of rendering a multi-channel audio (operations S804 to S806) is described in detail below.
S804: Parse the multi-channel media audio to determine a channel corresponding to each piece of audio data.

The multi-channel media audio includes N pieces of audio data, and after data parsing is performed on the multi-channel media audio, a channel corresponding to each of the N pieces of audio data can be determined. For example, an audio format (AVAudioFormat) of each piece of audio data in a multi-channel media audio may be parsed. The audio format identifies a channel type of corresponding audio data. For example, the channel type includes: left channel (L), right channel (R), center channel (C), left surround channel (Ls), right surround channel (Rs), and the like.
S805: Obtain a channel deployment association rule, where the channel deployment association rule defines that: each of the N virtual speakers is associated with one of the N channels.

Specifically, one piece of audio data in a multi-channel media audio corresponds to one channel, and different channels correspond to different spatial positions in a media playback scene. Different spatial positions are correspondingly deployed with matching virtual speakers. Therefore, a channel that each virtual speaker needs to be associated with may be defined in the channel deployment association rule. For example, the left speaker is configured to be associated with a left channel (L), the right speaker is configured to be associated with a right channel (R), and the center speaker is configured to be associated with a center channel (C).
S806: Perform audio rendering processing on the N pieces of audio data for the N channels by using N virtual speakers based on the channel deployment association rule and a channel corresponding to each audio frame. One virtual speaker is configured to perform rendering processing on audio data of one channel.

In a possible implementation, any one of the N virtual speakers is represented as an i^{th} virtual speaker, and i is a positive integer and 1≤i≤N. The performing, by the computer device, audio rendering processing on the N pieces of audio data for the N channels by using N virtual speakers based on the channel deployment association rule and a channel corresponding to each audio frame specifically includes the following operations (1) and (2):
(1) Obtain, from the N pieces of audio data based on the channel deployment association rule and the channel corresponding to each piece of audio data, target audio data that needs to be processed by the i^{th} virtual speaker; where the target audio data includes K audio frames with a channel type i. Specifically, because the channel deployment association rule defines an associated channel corresponding to each virtual speaker, target audio data that needs to be processed by any virtual speaker (an i^{th} virtual speaker) may be determined from the N pieces of audio data. As shown in FIG. 6B, it is assumed that the N speakers include: a left speaker S1′, a right speaker S2′, a center speaker S3′, a low frequency effect speaker S4′, a left surround speaker S5′, a right surround speaker S6′, a left surround back speaker S7′, a right surround back speaker S8′, a height left center speaker S9′, and a height right center speaker S10′. Therefore, the left speaker S1′ is configured to process audio data of a left channel (L), the right speaker S2′ is configured to process audio data of a right channel (R), the center speaker S3′ is configured to process audio data of a center channel (C), . . . , and so on. Audio data that needs to be processed by each virtual speaker may be determined, and one virtual speaker is configured to process audio data of one channel. Details are shown in the following Table 1:

TABLE 1
Audio data of corresponding channels that need to processed
by the N virtual speakers respectively

| Virtual speaker | | |
|---|---|---|
| Identifier | Name | Channel identifier |
| S1' | Left speaker | Left (L) |
| S2' | Right speaker | Right (R) |
| S3' | Center speaker | Center (C) |
| S4' | Low frequency effect speaker | Low frequency effect |
| | | (LFE) |
| S5' | Left surround speaker | Left surround (LS) |
| S6' | Right surround speaker | Right surround (RS) |
| S7' | Left surround back speaker | Surround back left |
| | | (SBL) |
| S8' | Right surround back speaker | Surround back right |
| | | (SBR) |
| S9' | Height left center speaker | Height left (HL) |
| S10' | Height right center speaker | Height right (HR) |

(2) Perform audio rendering processing on the target audio data by using the i^{th} virtual speaker. During specific implementation, a process of audio rendering on the target audio data by using the i^{th} virtual speaker is as follows:
\textcircled{1} Construct an audio buffer queue, where the audio buffer queue is used to store P to-be-processed audio frames, where P is a preset quantity threshold, and P is a positive integer. From selection of a complete audio file by a user to playback start and sound hearing, complex processes are performed: audio and video demultiplexing, audio decoding, audio post-processing, receiving an audio frame, constructing an audio structure description, copying audio frame data, switching to a main thread to play an audio (audio rendering), and the like. Each audio frame needs to be re-constructed into an audio structure description, then data is copied to a pulse code modulation (PCM) buffer, and finally audio rendering is completed. In an audio rendering process, if an audio frame is excessively small, processing frequency increases, resulting in relatively large time consumption of a system. If an audio frame is excessively large, a total time consumption of an entire process is increased because a time consumption of receiving an audio frame is excessively large. The foregoing two cases are represented as sound stuttering or the presence of rustling sound in experience. Therefore, it is very important to properly set a size value of each audio frame. In an actual application, from the perspective of collected data and a running effect, a solution in which original frames are buffered to a particular quantity and then are uniformly processed is relatively proper. Therefore, in some embodiments, in an audio rendering process, a buffer (for example, an audio buffer queue) needs to be pre-constructed to perform accumulation processing on multiple audio frames, to improve processing efficiency.
\textcircled{2} Obtain a to-be-processed audio frame j from K audio frames included in the target audio data, and add the audio frame j to the audio buffer queue, where j is a positive integer and 1≤j≤K. In an embodiment, before the adding the audio frame j (that is, any of the K audio frames) to the audio buffer queue, the method may further include:
I. Obtain a tail audio frame at a tail position of the audio buffer queue, where the tail audio frame herein is the last audio frame in the audio buffer queue.
II. Analyze the first attribute information of the audio frame j and the second attribute information of the tail audio frame, where the attribute information includes: any one or more of a sample rate (that is, a signal sampling frequency sampleRate, such as 44100 Hz or 48000 Hz), a quantity of bytes, and an audio format (for example, PCM or AAC). Therefore, it may be compared herein whether an audio format of the audio frame j is the same as an audio format of the tail audio frame, whether a sample rate of the audio frame j is the same as a sample rate of the tail audio frame, and whether a quantity of bytes of the audio frame j is the same as a quantity of bytes of the tail audio frame.
III. Trigger to perform the operation of adding the audio frame j to the audio buffer queue if the first attribute information of the audio frame j is the same as the second attribute information of the tail audio frame (this can be understood as that the audio frame j and the tail audio frame are two audio frames with the same attribute). Otherwise, if the first attribute information of the audio frame j is different from the second attribute information of the tail audio frame, the audio frame j and the tail audio frame are two audio frames with different attributes. In this case, data analysis is performed on the audio frame j, to construct an audio structure description of the audio frame j; and rendering processing is performed on the audio frame j based on the audio structure description of the audio frame j by using the i^{th} virtual speaker. This manner is to ensure that formats or attributes of the audio frames added to the audio buffer queue are the same, and further lay a foundation for subsequent reusing of a common audio structure description.
\textcircled{3} setting j=j+1, repeat the above processes I to III, and when the quantity of audio frames stored in the audio buffer queue reaches the preset quantity threshold P, perform audio rendering processing on the P audio frames in the audio buffer queue by using the i^{th} virtual speaker. Specifically, a process of performing audio rendering on the P audio frames in the audio buffer queue is as follows: I. Perform data analysis on any of the P audio frames, to construct an audio structure description corresponding to the audio buffer queue. II. Invoke a system conversion interface to respectively perform format conversion processing on the P audio frames, to convert the P audio frames into a buffer format. A buffer format herein can be understood as an audio format that the system can handle. III. Create P encoded data frames (for example, PCM data frames) based on each audio frame of the buffer format. IV. Perform multiplex rendering processing on the P encoded data frames based on the audio structure description by using the i^{th} virtual speaker.

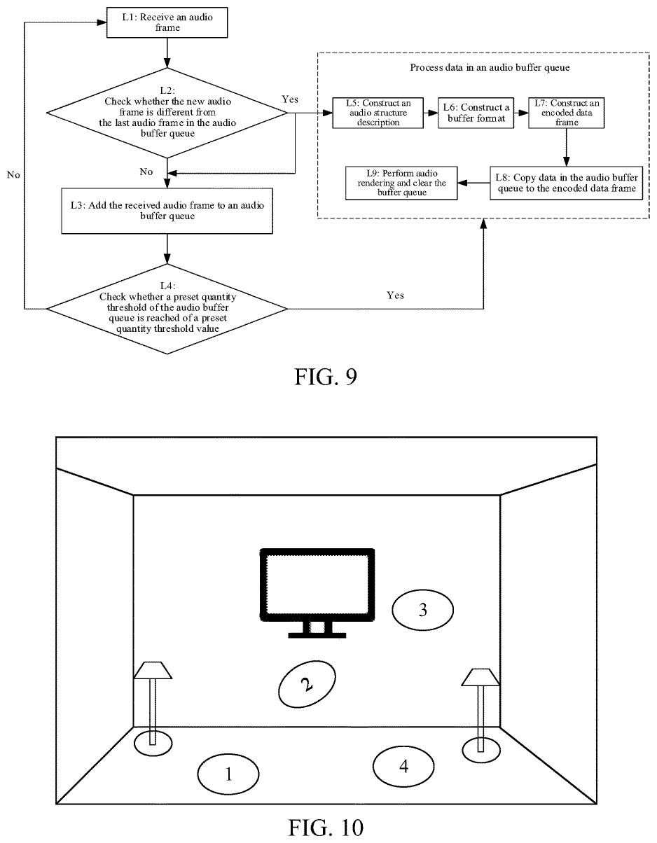

To sum up the processes shown in the foregoing operations \textcircled{1} to \textcircled{3}, in a process of performing audio rendering processing, unified rendering processing may be performed on multiple (for example, P) audio frames in a manner of constructing an audio buffer queue, so that rendering efficiency can be improved. Based on this, any virtual speaker is configured to perform independent rendering on audio data of a corresponding channel, so that the N virtual speakers may jointly implement multi-channel audio rendering on audio data (multi-channel media audio) of the N channels. An audio rendering process performed by any virtual speaker is described again below with reference to the accompanying drawings. Referring to FIG. 9, FIG. 9 is a schematic flowchart of audio rendering according to one or more embodiments. As shown in FIG. 9, the audio rendering process includes the following operations L1 to L9:
L1: Receive an audio frame (for example, the audio frame j, that is, any one of the K audio frames).
L2: Check whether the new audio frame is different from the last audio frame in the audio buffer queue (that is, it is compared whether attributes of the audio frame j and the tail audio frame are different). If yes, perform L5 to L9. If not, perform operation L3.
L3: Add the received audio frame to an audio buffer queue.
L4: Check whether a preset quantity threshold of the audio buffer queue is reached. If not, perform operation L1. If yes, perform L5 to L9.
L5: Construct an audio structure description.

Specifically, the audio structure description is used for describing at least one type of attribute information of any audio frame. The audio structure description AudioStreamBasicDescription is a structure used for describing a basic attribute of an audio stream in a core audio framework, and defines attribute information of audio data, including but not limited to information such as a sample rate, a quantity of channels, and a quantity of bits of each sample. The following describes fields included in the audio structure description AudioStreamBasicDescription:
1. mSampleRate: a sample rate, indicating a quantity of times of sampling per second. Common sample rates include 44100 Hz (CD sound quality) and 48000 Hz (professional audio and video).
2. mFormatID: an identifier of an audio format. Common formats include:
kAudioFormatLinearPCM: linear pulse code modulation (PCM), that is, a lossless audio format.
kAudioFormatMPEG4AAC: advanced audio coding (AAC), that is, a lossy audio format.
3. mFormatFlags: a format flag, used for describing a specific characteristic of an audio format. For example, for the PCM format, whether it is a floating-point number or an integer, whether it is big endian or small endian, or the like may be specified.
4. mBytesPerPacket: a quantity of bytes of each data packet. For a non-compressed audio (for example, PCM), this value is usually mBytesPerFrame×mFramesPerPacket.
5. mFramesPerPacket: a quantity of frames of each data packet. For a non-compressed audio (for example, PCM), each data packet usually includes one frame, and therefore, this value is usually 1. For a compressed audio (for example, AAC), this value may be 1024 or 2048.
6. mBytesPerFrame: a quantity of bytes per frame. For a non-compressed audio (for example, PCM), this value is usually mChannelsPerFrame×(mBitsPerChannel/8).
7. mChannelsPerFrame: a quantity of channels of each frame. For example, a value of a single-channel audio is 1, a value of a stereophonic audio is 2, and a value of an N-channel audio is N.
8. mBitsPerChannel: a quantity of bits of each channel. For example, for a 16-bit PCM audio, this value is 16.
9. mReserved: a reserved field, which is usually set to 0.

Based on this, because the audio structure description can reflect multidimensional attribute information of any audio frame and provides detailed descriptions of audio data, the audio structure description is very important data during audio programming, so that an audio processing and playback device can correctly interpret and process the audio data.
L6. Construct a buffer format. The buffer format AVAudioFormat herein may be understood as an audio format that a system can identify or process, so that the system effectively processes audio data.
L7. Construct an encoded data frame (for example, a PCM data frame). Herein, AVAudioPCMBuffer needs to be created, and AVAudioPCMBuffer is used to store a PCM data frame that can be identified and processed by a system.
L8. Copy data in the buffer queue to the encoded data frame (for example, a PCM data frame).
L9. Perform audio rendering and clear the buffer queue.

Based on this, as can be known from the process shown in FIG. 9, in some embodiments, an audio buffer queue is constructed, so that P audio frames having the same format or attribute are added to the queue to perform unified rendering processing. In a rendering process of the P audio frames in the audio buffer queue, a common audio structure description may be reused, and only one common audio structure description needs to be constructed for the P audio frames, thereby avoiding repeated construction to improve audio rendering efficiency, and reducing time consumed by thread switching, to improve smoothness of audio playback.
S807: Play, by using the stereo speaker system, the multi-channel media audio on which the multi-channel audio rendering processing is performed.

Specifically, after each virtual speaker in the stereo speaker system performs rendering processing on an audio signal of a corresponding channel that the speaker is responsible for rendering, the audio signal obtained after the audio rendering may be played at a corresponding directional position in the media playback scene. The N virtual speakers may simultaneously create a stereo surround sound effect after multi-channel rendering. Referring to FIG. 10, FIG. 10 is a schematic diagram of multi-channel rendering of a stereo speaker system according to one or more embodiments. As shown in FIG. 10, 4 virtual speakers (1, 2, 3, and 4) are deployed in the media playback scene. The four virtual speakers are respectively responsible for rendering audio signals of channels of the four virtual speakers in the media playback scene, so that a stereo surround play effect of the multi-channel media audio can be achieved around a media viewing object in the media playback scene.

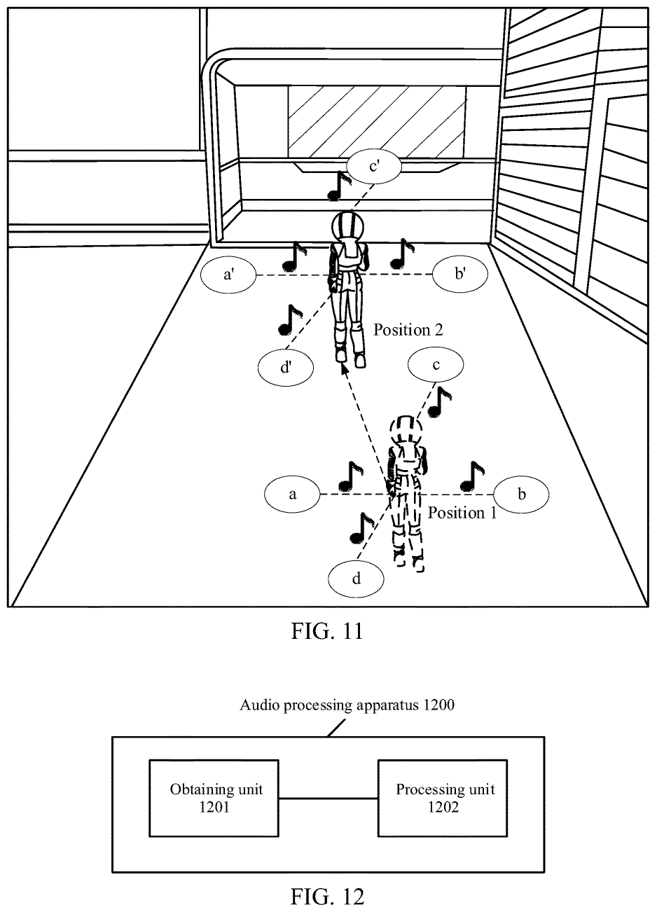

Referring to FIG. 11, FIG. 11 is a schematic diagram of a media playback scene according to one or more embodiments. As shown in FIG. 11, a to-be-played multi-channel media audio (assuming that the multi-channel media audio is generated after signal collection is performed by using four channels) is obtained in a media playback scene, and a real-time spatial position (for example, a position 1) of a media viewing object can be determined in the media playback scene. Based on the audio processing method provided in some embodiments, a stereo speaker system 1 may be deployed around the position 1, that is, four virtual speakers need to be deployed. The four virtual speakers (a, b, c, d) are respectively located on the left, right, front, and rear of the media viewing object in the media playback scene. Therefore, the four virtual speakers a, b, c, and d may separately perform independent rendering on an audio signal on a left channel, an audio signal on a right channel, an audio signal on a front channel, and an audio signal on a rear channel, to achieve a multi-channel audio rendering effect, so that the media viewing object can hear sound from four directions of left, right, front, and rear in the media playback scene, thereby providing immersive audio playback experience for the media viewing object. Further, if a media viewing object moves from the position 1 to a position 2 in the media playback scene, a stereo speaker system 2 may be deployed around the position 2. The stereo speaker system 2 includes four virtual speakers: a′, b′, c′, and d′. Deployment positions of the four virtual speakers (a′, b′, c′, and d′) in the media playback scene change based on a change of a real-time position of the media viewing object, and audio rendering and playback are respectively performed in the media playback scene based on a new position. Therefore, although a position of the media viewing object moves in a process of viewing the media, some embodiments can also deploy a stereo speaker system around the user in real time according to the real-time position of the user (the media viewing object). Further, immersive audio playback experience can be provided for the media viewing object, and dynamic changes can be made to match changes of the position of the user, so as to improve spatial and stereo quality of audio playback.

In some embodiments, on one hand, a multi-channel media audio is abstracted into a virtual speaker (ModelEntity) in a 3D space according to a spatial position of a speaker in a media playback scene during signal collection, to separately perform audio rendering and playback, so as to recover a scene of a multi-channel sound system in a real scene, thereby greatly improving auditory experience of the spatial audio. On the other hand, in a process of deploying the stereo speaker system, the stereo speaker system can be deployed around a media viewing object according to a real-time position of the media viewing object, and can match a change of a position of the user to dynamically change, so as to improve spatial and stereo quality of audio playback, thereby providing immersive audio playback experience for the media viewing object.

An apparatus related to an audio processing solution provided in some embodiments is described below.

In some embodiments, the term “module” or “unit” refers to a computer program or a part of a computer program with a predetermined function, which works together with other related parts to achieve a predetermined objective, and may be fully or partially implemented using software, hardware (for example, a processing circuit or a memory), or a combination thereof. Similarly, one processor (or multiple processors or memories) may be configured to implement one or more modules or units. In addition, each module or unit may be a part of an overall module or unit including a function of the module or unit.

Referring to FIG. 12, FIG. 12 is a schematic structural diagram of an audio processing apparatus according to one or more embodiments. The audio processing apparatus 1200 may be configured to perform corresponding operations in the audio processing method provided in some embodiments. In a specific implementation, the audio processing apparatus 1200 may specifically include:

an obtaining unit 1201, configured to obtain a multi-channel media audio in a media playback scene, the multi-channel media audio including audio signals collected by using N channels, each channel corresponding to a different spatial position in the media playback scene, and N being an integer greater than 1; and

a processing unit 1202, configured to obtain a target spatial position of a media viewing object in the media playback scene, and deploy a stereo speaker system around the target spatial position in the media playback scene; the stereo speaker system including N virtual speakers, and a deployment position of each virtual speaker in the media playback scene matching a spatial position of a channel in the media playback scene;

the processing unit 1202 being further configured to perform multi-channel audio rendering processing on the multi-channel media audio by using the stereo speaker system; each virtual speaker in the stereo speaker system performing audio rendering processing on an audio signal collected by a matching channel; and

the processing unit 1202 being further configured to play, by using the stereo speaker system, the multi-channel media audio on which the multi-channel audio rendering processing is performed.

In a possible implementation, the multi-channel media audio includes N pieces of audio data, and one piece of audio data is an audio signal collected by one channel; the processing unit 1202 is further configured to perform the following operations:
obtaining a collected multi-channel audio signal source in the media playback scene;
performing framing processing on the multi-channel audio signal source, to obtain K multi-channel audio frames, where each multi-channel audio frame is formed by audio signals of N channels; and
performing format resampling processing on the multi-channel audio signal source by using a channel segmentation technology, to perform signal segmentation on each multi-channel audio frame according to different channels, to obtain N pieces of audio data; where any one piece of audio data includes K audio frames, K audio frames included in one piece of audio data all belong to the same channel, and K is a positive integer;
where the channel segmentation technology includes: any one of audio editing software, an audio segmentation tool, and an audio processing framework.

In a possible implementation, the processing unit 1202 is further configured to perform the following operations:
performing audio preprocessing on the multi-channel audio signal source, to obtain a preprocessed multi-channel audio signal source; where the audio preprocessing includes any one or more of echo cancellation processing, noise suppression processing, normalization processing, and voice activity detection; and
performing format resampling processing on the preprocessed multi-channel audio signal source by using a channel segmentation technology, to obtain N pieces of audio data.

In a possible implementation, the multi-channel media audio is obtained by collecting an audio signal by using N physical speakers, and one physical speaker is configured to collect an audio signal of one channel at one spatial position in the media playback scene.

When deploying a stereo speaker system around a target spatial position in a media playback scene, the processing unit 1202 is configured to perform the following operations:
analyzing the multi-channel media audio, and determining a reference speaker deployment of the N physical speakers in a signal collection process, where the reference speaker deployment includes: a distance and a direction between each physical speaker and a reference spatial position in the media playback scene; and
deploying the stereo speaker system in the media playback scene based on the target spatial position and the reference speaker deployment.

In a possible implementation, the target spatial position is represented by using three-dimensional space coordinates (x, y, z), any of the N physical speakers is represented as a physical speaker a, and a is a positive integer and 1≤a≤N; and the distance between the physical speaker a and the reference spatial position includes: a first distance d1, a second distance d2, and a third distance d3.

When deploying the stereo speaker system in the media playback scene based on the target spatial position and the reference speaker deployment, the processing unit 1202 is configured to perform the following operations:
calculating a candidate position (x′, y′, z′) of a to-be-deployed virtual speaker b based on the target spatial position (x, y, z), the first distance d1, the second distance d2, and the third distance d3 between the physical speaker a and the reference spatial position; and
deploying the virtual speaker b in the media playback scene based on the candidate position (x′, y′, z′) of the virtual speaker b and the direction of the physical speaker a in the media playback scene.

In a possible implementation, when deploying the virtual speaker b in the media playback scene based on the candidate position (x′, y′, z′) of the virtual speaker b and the direction of the physical speaker a in the media playback scene, the processing unit 1202 is configured to perform the following operations:
determining a to-be-deployed spatial position of the virtual speaker b in the media playback scene based on the candidate position (x′, y′, z′); where a distance between the to-be-deployed spatial position and the candidate position is less than a preset threshold;
determining the direction of the physical speaker a in the media playback scene as a to-be-deployed direction of the virtual speaker b in the media playback scene;
setting a speaker attribute for the virtual speaker b, where the speaker attribute includes: any one or more of a geometric shape, a material, and a color; and
deploying the virtual speaker b in the media playback scene according to the to-be-deployed spatial position, the to-be-deployed direction, and the speaker attribute.

In a possible implementation, the processing unit 1202 is further configured to perform the following operations:
analyzing the multi-channel media audio, and determining an audio type of the multi-channel media audio;
obtaining multiple corresponding multi-channel speaker deployments in the media playback scene; where any one of the multi-channel speaker deployments is configured to specify spatial deployment information of the N physical speakers in a signal collection process; and
determining, based on the audio type, a multi-channel speaker deployment matching the audio type from the multiple multi-channel speaker deployments, and using the determined multi-channel speaker deployment as the reference speaker deployment.

In a possible implementation, the multi-channel media audio includes N pieces of audio data, and one piece of audio data includes K audio frames from the same channel; and when performing multi-channel audio rendering processing on the multi-channel media audio by using the stereo speaker system, the processing unit 1202 is configured to perform the following operations:
parsing the multi-channel media audio to determine a channel corresponding to each piece of audio data;
obtaining a channel deployment association rule, where the channel deployment association rule defines that: each of the N virtual speakers is associated with one of the N channels; and
performing audio rendering processing on the N pieces of audio data for the N channels by using N virtual speakers based on the channel deployment association rule and a channel corresponding to each audio frame; where one virtual speaker is configured to perform rendering processing on audio data of one channel.

In a possible implementation, any one of the N virtual speakers is represented as an i^{th} virtual speaker, and i is a positive integer and 1≤i≤N; and when performing audio rendering processing on the N pieces of audio data for the N channels by using N virtual speakers based on the channel deployment association rule and a channel corresponding to each audio frame, the processing unit 1202 is configured to perform the following operations:
obtaining, from the N pieces of audio data based on the channel deployment association rule and the channel corresponding to each piece of audio data, target audio data that needs to be processed by the i^{th} virtual speaker; where the target audio data includes K audio frames whose channel type is a channel i; and
performing audio rendering processing on the target audio data by using the i^{th} virtual speaker.

In a possible implementation, when performing audio rendering processing on the target audio data by using the i^{th} virtual speaker, the processing unit 1202 is configured to perform the following operations:
constructing an audio buffer queue, where the audio buffer queue is used to store P to-be-processed audio frames, where P is a preset quantity threshold, and P is a positive integer;
obtaining a to-be-processed audio frame j from K audio frames included in the target audio data, and adding the audio frame j to the audio buffer queue; where j is a positive integer and 1≤j≤K; and
setting j=j+1, when the quantity of audio frames stored in the audio buffer queue reaches the preset quantity threshold P, performing audio rendering processing on the P audio frames in the audio buffer queue by using the i^{th} virtual speaker.

In a possible implementation, when performing audio rendering processing on the P audio frames in the audio buffer queue by using the i^{th} virtual speaker, the processing unit 1202 is configured to perform the following operations:
performing data analysis on any of the P audio frames, to construct an audio structure description corresponding to the audio buffer queue; where the audio structure description is configured to describe at least one type of attribute information of any audio frame;
invoking a system conversion interface to respectively perform format conversion processing on the P audio frames, to convert the P audio frames into a buffer format;
creating P encoded data frames based on each audio frame of the buffer format; and
performing multiplex rendering processing on the P encoded data frames based on the audio structure description by using the i^{th} virtual speaker.

In a possible implementation, before adding the audio frame j to an audio buffer queue, the processing unit 1202 is further configured to perform the following operations:
obtaining a tail audio frame at a tail position in the audio buffer queue;
analyzing first attribute information of the audio frame j and second attribute information of the tail audio frame, where the attribute information includes: any one or more of a sample rate, a quantity of bytes, and an audio format; and
triggering to perform the operation of adding the audio frame j to the audio buffer queue if the first attribute information of the audio frame j is the same as the second attribute information of the tail audio frame.

In a possible implementation, the processing unit 1202 is further configured to perform the following operations:
if the first attribute information of the audio frame j is different from the second attribute information of the tail audio frame, performing data analysis on the audio frame j, to construct an audio structure description of the audio frame j; and
performing rendering processing on the audio frame j based on the audio structure description of the audio frame j by using the i^{th} virtual speaker.

In some embodiments, a multi-channel media audio in a media playback scene is obtained, the multi-channel media audio including audio signals collected by using N channels, each channel corresponding to a different spatial position in the media playback scene, and N being an integer greater than 1; a target spatial position of a media data viewing object in the media playback scene is obtained, and a stereo speaker system is deployed around the target spatial position in the media playback scene; the stereo speaker system including N virtual speakers, and a deployment position of each virtual speaker in the media playback scene matching a spatial position of a channel in the media playback scene; multi-channel audio rendering processing is performed on the multi-channel media audio by using the stereo speaker system, each virtual speaker in the stereo speaker system performing audio rendering processing on an audio signal collected by a matching channel; and the multi-channel media audio on which the multi-channel audio rendering processing is performed is played by using the stereo speaker system. As can be seen, in some embodiments, in a process of deploying the stereo speaker system, virtual recovery can be performed according to a spatial position of the multi-channel media audio during collection, to determine a deployment position of a virtual speaker, so that a real sound environment of the media audio can be recovered as much as possible in the media playback scene, thereby improving realness of an audio playback effect. In addition, in some embodiments, N virtual speakers are configured to separately render audio signals collected by N channels, so that a rendering effect of the multi-channel spatial audio can be achieved, and stereo and spatial quality of audio playback are improved, thereby improving immersive experience in the media playback scene.

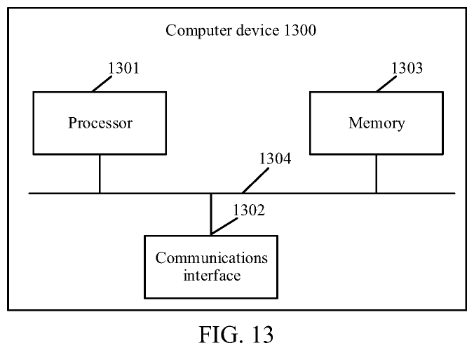

Referring to FIG. 13, FIG. 13 is a schematic structural diagram of a computer device according to one or more embodiments. The computer device 1300 is configured to perform operations performed by the computer device in the foregoing method embodiments. The computer device 1300 may include a device (for example, one or more of a server, a node, and a terminal), or may include an internal component (for example, a chip, a software module, or a hardware module) within a device. The computer device may include at least one processor 1301 and a communications interface 1302. In an embodiment, the computer device may further include at least one memory 1303 and a bus 1304. In addition, the processor 1301, the communications interface 1302, and the memory 1303 are connected by using the bus 1304.
(1) The processor 1301 is a module that performs arithmetic operations and/or logical operations, and may be specifically one or a combination of more of processing modules such as a central processing unit (CPU), a graphics processing unit (GPU), a microprocessor unit (MPU), an application-specific integrated circuit (ASIC), a field programmable gate array (FPGA), a complex programmable logic device (CPLD), a co-processor (assisting a central processing unit in completing corresponding processing and application), and a micro controller unit (MCU).
(2) The communications interface 1302 may be configured to provide information input or output for the at least one processor 1301. The communications interface 1302 may be configured to receive data sent externally and/or send data, and may be a wired link interface including an Ethernet cable, or may be a wireless link (Wi-Fi, Bluetooth, general wireless transmission, an in-vehicle short range communications technology, another short range wireless communications technology, or the like) interface. The communications interface 1302 may be used as a network interface.
(3) The memory 1303 is configured to provide storage space, and the storage space may store data such as an operating system and a computer program (the computer program includes a program instruction). The memory 1303 may be one or a combination of multiple of a random access memory (RAM), a read-only memory (ROM), an erasable programmable read-only memory (EPROM), a compact disc read-only memory (CD-ROM), or the like.

In specific implementation, the processor 1301 runs the program instructions in the memory 1303, so that the computer device performs the method operations in the foregoing embodiments. In addition, after the computer device performs the method operations in the embodiments by using the processor, for an achieved effect, refer to descriptions in the foregoing embodiments, and details are not described herein again.

Some embodiments further provide a computer-readable storage medium, having a computer program stored therein, and the computer program includes program instructions. When the program instructions are executed by a processor, the methods in the foregoing corresponding embodiments can be executed, and therefore details are not described herein again. For technical details that are not disclosed in the computer readable storage medium embodiments of the disclosure, refer to the descriptions of the method embodiments of the disclosure. In an example, the program instructions may be deployed to be executed on a computer device, or deployed to be executed on multiple computer devices at the same position, or deployed to be executed on multiple computer devices that are distributed in multiple positions and interconnected by using a communication network.

Some embodiments further provide a computer program product. The computer program product includes a computer program. The computer program is stored in a computer-readable storage medium. A processor of a computer device reads the computer instruction from the computer-readable storage medium, and the processor executes the computer instruction, so that the computer device can perform the method in the foregoing corresponding embodiment. Therefore, details are not described herein again. For technical details that are not disclosed in the computer program product embodiment of the disclosure, refer to the descriptions of the method embodiment of the disclosure.

All or some of the above embodiments may be implemented by means of software, hardware, firmware or their combinations. When the software is used for implementation, all or some of the embodiments may be implemented in a form of a computer program product. The computer program product includes one or more computer programs. When the computer programs are loaded and executed on a computer device, all or some of the processes or functions described in the embodiments of the disclosure are generated. The computer device may be a general-purpose computer, a dedicated computer, a computer network, or other programmable devices. The computer program may be stored in the computer-readable storage medium or transmitted through the computer-readable storage medium. The computer programs may be transmitted from one website, computer, server or data center to another website, computer, server or data center in a wired (for example, a coaxial cable, an optical fiber or a digital subscriber line (DSL)) or wireless (for example, infrared, wireless or microwave) manner. The computer-readable storage medium may be any usable medium accessible by the computer device, or a data processing device, for example, a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid state drive (SSD)), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An audio processing method, performed by a computer device, comprising:
obtaining a multi-channel media audio in a media playback scene, the multi-channel media audio comprising audio signals collected by using N channels, each of the N channels corresponding to a different spatial position in the media playback scene, and N being an integer greater than 1;
obtaining a target spatial position of a media viewing object in the media playback scene, and deploying a stereo speaker system around the target spatial position in the media playback scene, the stereo speaker system comprising N virtual speakers, and a deployment position of each of the N virtual speakers in the media playback scene matching a spatial position of one of the N channels in the media playback scene;
performing multi-channel audio rendering processing on the multi-channel media audio using the stereo speaker system, each of the N virtual speakers in the stereo speaker system performing audio rendering processing on an audio signal collected by a matching channel; and
playing, by the stereo speaker system, the multi-channel media audio on which the multi-channel audio rendering processing is performed.

2. The audio processing method according to claim 1, wherein the multi-channel media audio comprises N pieces of audio data, and one piece of the N pieces of audio data is an audio signal collected by one of the N channels; and
the audio processing method further comprises:
obtaining a multi-channel audio signal source in the media playback scene;
performing framing processing on the multi-channel audio signal source to obtain K multi-channel audio frames, each of the K multi-channel audio frames being formed by audio signals of the N channels; and
performing format resampling processing on the multi-channel audio signal source using a channel segmentation technology to perform signal segmentation on each of the K multi-channel audio frames according to different channels to obtain the N pieces of audio data; any one piece of audio data comprising K audio frames, K audio frames comprised in one piece of audio data all belong to the same channel, and K is a positive integer;
wherein the channel segmentation technology comprises any one of audio editing software, an audio segmentation tool, and an audio processing framework.

3. The audio processing method according to claim 2, further comprising:
performing audio preprocessing on the multi-channel audio signal source to obtain a preprocessed multi-channel audio signal source, the audio preprocessing comprising at least one of echo cancellation processing, noise suppression processing, normalization processing, and voice activity detection; and
performing format resampling processing on the preprocessed multi-channel audio signal source using channel segmentation technology to obtain the N pieces of audio data.

4. The audio processing method according to claim 1, wherein the multi-channel media audio is obtained by collecting audio signals by using N physical speakers; and each physical speaker being configured to collect an audio signal of one channel at one spatial position of the media playback scene; and
wherein the deploying the stereo speaker system around the target spatial position in the media playback scene comprises:
analyzing the multi-channel media audio, and determining a reference speaker deployment of the N physical speakers in a signal collection process, the reference speaker deployment comprising a distance and a direction between each physical speaker and a reference spatial position in the media playback scene; and
deploying the stereo speaker system in the media playback scene based on the target spatial position and the reference speaker deployment.

5. The audio processing method according to claim 4, wherein the target spatial position is represented by using three-dimensional space coordinates, any of the N physical speakers being represented as a physical speaker a, and a is a positive integer and 1≤a≤N; and the distance between the physical speaker a and the reference spatial position comprises: a first distance d1, a second distance d2, and a third distance d3; and
wherein the deploying the stereo speaker system in the media playback scene based on the target spatial position and the reference speaker deployment comprises:
calculating a candidate position for a virtual speaker b based on the target spatial position, the first distance d1, the second distance d2, and the third distance d3 between the physical speaker a and the reference spatial position; and
deploying the virtual speaker b in the media playback scene based on the candidate position of the virtual speaker b and the direction of the physical speaker a in the media playback scene.

6. The audio processing method according to claim 5, wherein the deploying the virtual speaker b in the media playback scene based on the candidate position of the virtual speaker b and the direction of the physical speaker a in the media playback scene comprises:
determining a to-be-deployed spatial position of the virtual speaker b in the media playback scene based on the candidate position, a distance between the to-be-deployed spatial position and the candidate position being less than a preset threshold;
determining the direction of the physical speaker a in the media playback scene as a to-be-deployed direction of the virtual speaker b in the media playback scene;
setting a speaker attribute for the virtual speaker b, the speaker attribute comprising at least one of a geometric shape, a material, and a color; and
deploying the virtual speaker b in the media playback scene according to the to-be-deployed spatial position, the to-be-deployed direction, and the speaker attribute.

7. The audio processing method according to claim 4, further comprising:
analyzing the multi-channel media audio, and determining an audio type of the multi-channel media audio;
obtaining multiple corresponding multi-channel speaker deployments in the media playback scene, any one of the multi-channel speaker deployments being configured to specify spatial deployment information of the N physical speakers in a signal collection process; and
determining, based on the audio type, a multi-channel speaker deployment matching the audio type from the multiple multi-channel speaker deployments, and using the determined multi-channel speaker deployment as the reference speaker deployment.

8. The audio processing method according to claim 1, wherein the multi-channel media audio comprises N pieces of audio data, and one piece of audio data comprises K audio frames from a same channel; and
wherein the performing multi-channel audio rendering processing on the multi-channel media audio using the stereo speaker system comprises:
parsing the multi-channel media audio to determine a channel corresponding to each piece of audio data;
obtaining a channel deployment association rule, the channel deployment association rule defining that each of the N virtual speakers is associated with one of the N channels; and
performing audio rendering processing on the N pieces of audio data for the N channels by using N virtual speakers based on the channel deployment association rule and a channel corresponding to each audio frame, one virtual speaker being configured to perform rendering processing on audio data of one channel.

9. The audio processing method according to claim 8, wherein any one of the N virtual speakers is represented as an i^{th} virtual speaker, and i is a positive integer and 1≤i≤N; and
wherein the performing audio rendering processing on the N pieces of audio data for the N channels by using N virtual speakers based on the channel deployment association rule and the channel corresponding to each audio frame comprises:
obtaining, from the N pieces of audio data based on the channel deployment association rule and the channel corresponding to each piece of audio data, target audio data that needs to be processed by the i^{th} virtual speaker, the target audio data comprising K audio frames whose channel type is a channel i; and
performing audio rendering processing on the target audio data by using the i^{th} virtual speaker.

10. The audio processing method according to claim 9, wherein the performing audio rendering processing on the target audio data by using the i^{th} virtual speaker comprises:
constructing an audio buffer queue, the audio buffer queue being used to store P audio frames to-be-processed, P is a preset quantity threshold, and P is a positive integer;
obtaining an audio frame j from K audio frames comprised in the target audio data, and adding the audio frame j to the audio buffer queue; j being a positive integer and 1≤j≤K; and
based on a quantity of audio frames stored in the audio buffer queue reaching the preset quantity threshold, performing audio rendering processing on the P audio frames in the audio buffer queue using the i^{th} virtual speaker.

11. The audio processing method according to claim 10, wherein the performing audio rendering processing on the P audio frames in the audio buffer queue using the i^{th} virtual speaker comprises:
performing data analysis on any of the P audio frames to construct an audio structure description corresponding to the audio buffer queue; the audio structure description being configured to describe at least one type of attribute information of any audio frame;
invoking a system conversion interface to respectively perform format conversion processing on the P audio frames to convert the P audio frames into a buffer format;
creating P encoded data frames based on each audio frame of the buffer format; and
performing multiplex rendering processing on the P encoded data frames based on the audio structure description by using the i^{th} virtual speaker.

12. The audio processing method according to claim 10, wherein before the adding the audio frame j to the audio buffer queue, the audio processing method further comprises:
obtaining a tail audio frame at a tail position in the audio buffer queue;
analyzing first attribute information of the audio frame j and second attribute information of the tail audio frame, the first attribute information and the second attribute information comprising at least one of a sample rate, a quantity of bytes, and an audio format; and
triggering to perform the operation of adding the audio frame j to the audio buffer queue based on the first attribute information of the audio frame j being a same as the second attribute information of the tail audio frame.

13. The audio processing method according to claim 12, further comprising:
based on the first attribute information of the audio frame j being different from the second attribute information of the tail audio frame, performing data analysis on the audio frame j to construct an audio structure description of the audio frame j; and
performing rendering processing on the audio frame j based on the audio structure description of the audio frame j by using the i^{th} virtual speaker.

14. An audio processing apparatus comprising:
at least one memory configured to store computer program code; and
at least one processor configured to read the program code and operate as instructed by the program code, the program code comprising:
obtaining code configured to cause at least one of the at least one processor to obtain a multi-channel media audio in a media playback scene, the multi-channel media audio comprising audio signals collected by using N channels, each of the N channels corresponding to a different spatial position in the media playback scene, and N being an integer greater than 1; and
processing code configured to cause at least one of the at least one processor to:
obtain a target spatial position of a media viewing object in the media playback scene, and deploy a stereo speaker system around the target spatial position in the media playback scene; the stereo speaker system comprising N virtual speakers, and a deployment position of each of the N virtual speakers in the media playback scene matching a spatial position of one of the N channels in the media playback scene;
perform multi-channel audio rendering processing on the multi-channel media audio by using the stereo speaker system, each of the N virtual speakers in the stereo speaker system performing audio rendering processing on an audio signal collected by a matching channel; and
play, by the stereo speaker system, the multi-channel media audio on which the multi-channel audio rendering processing is performed.

15. The audio processing apparatus according to claim 14, wherein the multi-channel media audio comprises N pieces of audio data, and one piece of the N pieces of audio data is an audio signal collected by one of the N channels;
wherein the processing code is further configured to cause at least one of the at least one processor to:
obtain a multi-channel audio signal source in the media playback scene;
perform framing processing on the multi-channel audio signal source to obtain K multi-channel audio frames, each of the K multi-channel audio frames being formed by audio signals of the N channels; and
perform format resampling processing on the multi-channel audio signal source using a channel segmentation technology to perform signal segmentation on each of the K multi-channel audio frames according to different channels to obtain the N pieces of audio data; any one piece of audio data comprising K audio frames, K audio frames comprised in one piece of audio data all belong to the same channel, and K is a positive integer; and
wherein the channel segmentation technology comprises any one of audio editing software, an audio segmentation tool, and an audio processing framework.

16. The audio processing apparatus according to claim 15, wherein the processing code is further configured to cause at least one of the at least one processor to:
perform audio preprocessing on the multi-channel audio signal source to obtain a preprocessed multi-channel audio signal source, the audio preprocessing comprising at least one of echo cancellation processing, noise suppression processing, normalization processing, and voice activity detection; and
perform format resampling processing on the preprocessed multi-channel audio signal source using channel segmentation technology to obtain the N pieces of audio data.

17. The audio processing apparatus according to claim 14, wherein the multi-channel media audio is obtained by collecting audio signals by using N physical speakers; and each physical speaker being configured to collect an audio signal of one channel at one spatial position of the media playback scene; and
wherein the processing code is further configured to cause at least one of the at least one processor to:
analyze the multi-channel media audio, and determining a reference speaker deployment of the N physical speakers in a signal collection process, the reference speaker deployment comprising a distance and a direction between each physical speaker and a reference spatial position in the media playback scene; and
deploy the stereo speaker system in the media playback scene based on the target spatial position and the reference speaker deployment.

18. The audio processing apparatus according to claim 17, wherein the target spatial position is represented by using three-dimensional space coordinates, any of the N physical speakers being represented as a physical speaker a, and a is a positive integer and 1≤a≤N; and the distance between the physical speaker a and the reference spatial position comprises: a first distance d1, a second distance d2, and a third distance d3; and
wherein the processing code is further configured to cause at least one of the at least one processor to:
calculate a candidate position for a virtual speaker b based on the target spatial position, the first distance d1, the second distance d2, and the third distance d3 between the physical speaker a and the reference spatial position; and
deploy the virtual speaker b in the media playback scene based on the candidate position of the virtual speaker b and the direction of the physical speaker a in the media playback scene.

19. The audio processing apparatus according to claim 18, wherein the processing code is further configured to cause at least one of the at least one processor to:
determine a to-be-deployed spatial position of the virtual speaker b in the media playback scene based on the candidate position, a distance between the to-be-deployed spatial position and the candidate position being less than a preset threshold;
determine the direction of the physical speaker a in the media playback scene as a to-be-deployed direction of the virtual speaker b in the media playback scene;
set a speaker attribute for the virtual speaker b, the speaker attribute comprising at least one of a geometric shape, a material, and a color; and
deploy the virtual speaker b in the media playback scene according to the to-be-deployed spatial position, the to-be-deployed direction, and the speaker attribute.

20. A non-transitory computer-readable storage medium, storing computer code which, when executed by at least one processor, causes the at least one processor to at least:
obtain a multi-channel media audio in a media playback scene, the multi-channel media audio comprising audio signals collected by using N channels, each of the N channels corresponding to a different spatial position in the media playback scene, and N being an integer greater than 1;
obtain a target spatial position of a media viewing object in the media playback scene, and deploying a stereo speaker system around the target spatial position in the media playback scene, the stereo speaker system comprising N virtual speakers, and a deployment position of each of the N virtual speakers in the media playback scene matching a spatial position of one of the N channels in the media playback scene;
perform multi-channel audio rendering processing on the multi-channel media audio using the stereo speaker system, each of the N virtual speakers in the stereo speaker system performing audio rendering processing on an audio signal collected by a matching channel; and
play, by the stereo speaker system, the multi-channel media audio on which the multi-channel audio rendering processing is performed.
